(19) United States
(12) Patent Application Publication
(10) Pub. No.: US 2020/0406118 A1
(43) Pub. Date: Dec. 31, 2020

(54) GOLF RELATED METHODS AND APPARATUS

(71) Applicant: CECELUMEN, LLC, Camarillo, CA (US)

(72) Inventor: James Buscemi, Camarillo, CA (US)

(21) Appl. No.: 16/917,854

(22) Filed: Jun. 30, 2020

Related U.S. Application Data
(60) Provisional application No. 62/869,551, filed on Jul. 1, 2019.
(60) Provisional application No. 62/869,003, filed on Jun. 30, 2019.

(51) Int. Cl. A63B 69/36; A63B 47/02; A63B 71/06; A63B 24/00

(52) U.S. Cl. CPC A63B 69/3694; A63B 47/021; A63B 71/0669; A63B 71/0622; A63B 24/0021; A63B 2220/89; A63B 2102/32; A63B 2220/807; A63B 2220/35; A63B 2225/54; A63B 2071/0625; A63B 2071/0694; A63B 2047/022; A63B 2220/805

(57) ABSTRACT

Sensors in a golf teeing booth are used to: detect that a ball has be driven and estimate a predicted ball landing point on a golf practice range. A mobile unmanned golf ball retrieval vehicle, sometimes referred to as a gofer, determines a precise ball location on the field and reports the results to a control system. The control system updates the golfer's score based on the determined precise ball location.

### RELATED APPLICATIONS

The present application claims the benefit of U.S. Provisional Application Ser. No. 62/869,003 filed Jun. 30, 2019 and U.S. Provisional Application Ser. No. 62/869,551 filed Jul. 1, 2019 each of which are hereby expressly incorporated by reference in their entirety.

### FIELD

The present application relates to golf related methods and apparatus, and more particularly, to methods and apparatus for evaluating golf practice results and for retrieving golf balls.

### BACKGROUND

Golf is game that is played by a wide variety of people. To improve their ability to accurately tee off and drive a golf ball to its intended destination, players often practice driving balls on what is sometimes referred to as a driving range. In the case of outdoor driving ranges, large metal nets are often set up, e.g., using telephone poles as the supports for the nets. In the case of an indoor range, nets and/or collection chutes may also be used but with a projected image of a golf course being displayed to the player hitting the ball.

In such systems, as a user drives a ball from a tee the ball flies through the air hitting one of the nets and the ball is directed into an individual one of a plurality of ball collection chutes depending on where the ball landed, e.g., hit the net. The ball collection chutes are equipped with RFID sensors. In at least some such systems, RFID chips are included in the individual golf balls, and the ID communicated by the ball is associated with one of the individuals using the driving range. As a ball passes the RFID sensor in a collection chute the ID of the ball is read and reported to a scoring system. By using a relatively large number of chutes, it is possible to distinguish between different areas of the golf course and thus where the ball landed or would have landed if it had not been intercepted by a net. The collected ID of the ball combined with the net chute where the ball was collected is used in providing the individual who hit the ball into the net information on their driving accuracy and/or a score.

RFID based driving range systems can be costly and/or difficult to implement and maintain for a variety of reasons. Firstly such systems often involve the need for nets and a relatively large number of collection chutes. Nets strong enough to survive the repeated impact of golf balls and high winds often need to be made of relatively strong and thus costly material. Furthermore many such systems involve the use of large poles, sometimes referred to as telephone poles, to support the nets. Furthermore such systems often require a large number of chutes and fixed RFID sensors to facilitate detection of where a ball lands. Balls with embedded RFID chips are more costly than regular golf balls without such chips. RFID readers may fail requiring service by a skilled technician. Furthermore since an RFID sensor is tied to a particular chute, failure of an RFID sensor may degrade scoring since there may be no way to accurately detect balls entering the particular chute where an RFID sensor failed.

In many locations, there is ample room to allow golf balls to be driven without fear of where they may land. In such cases, the need for large steel nets to implement a driving range is due, at least in part, to direct the balls into different chutes.

While a driving range with nets is useful and beneficial to many players, a more realistic driving experience is desirable. In particular it would be desirable if players could drive their balls on a green, have their ball impact location accurately determined, and have the driven balls collected without the need for nets or other artificial structures that direct balls to chutes at fixed locations. While not necessary for all embodiments it would be desirable if at least some embodiments did not rely on the use of RFID chips. In addition, while not necessary for all embodiments it would be desirable if at least some embodiments supported real or near real time feedback and scoring based on the actual landing location of one or more driven balls.

### SUMMARY

Method and apparatus for supporting various golf related activities are described. In various embodiments a driving range is supported through the use of mobile battery operated ball retrieval devices, which are mobile ball retrieval units, referred to herein as gofers. The gofers are sometimes implemented as semi-autonomous electrical vehicles, e.g., battery operated carts, which include a ball collection device, ball storage area, wireless interface, one or more sensors, e.g., cameras, range finders, target locators and/or position sensors, and/or a processor for controlling gofer operation and reporting of ball collection and position information. The gofers are automated mobile vehicles that operate as ball collection devices but which, in at least some embodiments, also serve to provide detailed information about where a ball landed. Multiple gofers can be used together to cover a relatively large physical area of a golf course but with each gofer unit servicing a small area. In some embodiments the gofers act collectively to provide coverage of a large area allowing for balls to be driven and retrieved without the need for collection nets.

In various embodiments ball impact and/or landing location are observed by the gofer unit and the impact or landing location determined using a targeting device, range finder, captured image, and/or optical or sensor measurement to accurately determine the ball impact and/or landing location as well as the time of impact and/or landing. In some embodiments this information is wirelessly communicated back to a controller before the ball is collected. Sensor determined impact or landing location information can be and sometimes is updated or supplemented based on information about the precise location a ball is collected. Alternatively, in less time critical implementations a ball can be, and sometimes is, collected, an RFID or optical marker examined and the precise collection point reported as the ball landing location.

While robotic devices, e.g., the gofers in some embodiments, can be used to collect balls from a fixed area, e.g., with a golf hole to which players direct balls, in other embodiments players direct balls at one or more moving targets. In at least some such embodiments one or more gofers follow the moving target, detect where balls land and/or come to rest and collect balls. The gofers can move as the target moves. The moving targets may be dynamic and travel a time varying path, e.g., under direction of the control system or according to a preprogrammed path loaded into the memory of the dynamic target. The target may be carried by a gofer unit which, rather than collect balls in such a case, serves to move the target around. Thus in at least some embodiments dynamic targets that are unmanned and mobile are used alone or in combination with gofers used to collect balls. The targets in addition to the gofers and bays may include one or more sensors to detect ball motion or resting location. Robotic devices, e.g., gofer units, follow the mobile target in some embodiments to detect ball resting location and to collect information which can be used to match a detected ball to an individual player, e.g., golfer hitting the balls from a bay. While in some embodiments RFID chips are not used in the balls, in other embodiments golf balls with RFID chips are used. The gofers detect RFIDs for balls near the target, e.g., as they come to rest and/or are collected. Scores are generated for a shot, e.g., hit ball that is collected, via a ball location determination made by the gofer unit or by location information provided by the gofer unit in combination with other sensor information. Differential GPS may be, and sometimes is, used as part of the ball location determination process. An RFID reader is used to detect an RFID associated with the ball that is being collected in some embodiments. In other embodiments a camera is used to detect a visual identifier such as a color on the mark or ball. RFID and camera based identification techniques may be, and sometimes are, used alone or in combination. With the cameras and/or RFID readers being on the mobile target and/or gofers. Based on the RFID of the ball read by an RFID reader or the visually detected ID an individual ball is associated with the booth, also sometimes as a bay, from which the ball was hit and the person who hit the ball which is being collected and used for scoring. While the gofer unit can detect the final resting spot, sensors in the bay or booth, from where the ball is hit, are used to make an initial estimation of the balls path and landing area with the retrieval unit providing final more detailed ball resting area information in cases where the ball landing area is detected by a gofer unit and/or retrieved by a gofer unit. In the case where a ball is not retrieved for some reason the score is generated based on the sensor data and prediction of the ball landing area. In this way even when a ball is not recovered, a score is generated for the user. The sensors in the bay from which the ball is hit may, and sometimes do, include radar and cameras with a combination of 3D Doppler tracking and image capture and processing being used in some embodiments to predict a balls flight path. Commercial path prediction systems such as FlightScope can be, and are sometimes, used to predict the balls flight path and to approximate the ball final resting spot in the range. The robots, e.g., gofers, used to collect balls and provide detailed ball resting area information have, in some embodiments, sensors, e.g., cameras, RFID sensors, and/or laser ranging sensors, to detect balls near the ball collection robot and to augment the other sensor data in the bay and/or the dynamic targets. In this way sensor data can be collected from multiple devices located at different locations and used for scoring one or multiple players.

Gofers include cameras and/or other sensors to detect a ball on the golf course. Using knowledge about it own position on the field the gofer can, and sometimes does, determine the position of a golf ball, retrieve the ball and report the landing location, e.g., location of retrieval, back to a scoring and/or reporting system via wireless signal. While RFID chips can be included in the ball and detected by the gofer unit upon retrieval, in at least some embodiments RFID chips are not used and knowledge of where a player's ball was likely to land alone or in combination with visual markings on the ball are used to determine the player to which the detected ball corresponds.

In at least some embodiments, individual players tee off from a booth. One or more sensors are included in the booth to detect the movements of the golf swing and/or motion of the ball. In some embodiments one or more infrared (IR) sensors are used to track direction and speed of the club used by the player. In other embodiments one or more high speed cameras are used to detect the speed and spin of the ball. The high speed camera approach is more accurate but also more expensive. In still other embodiments a radar system is used to detect speed and/or ball direction. In some embodiments a combination of IR/camera and/or radar sensor are used. Sensor information collected from the booth where the player swings and hits the ball is processed and used to make a prediction as to where the ball hit by the player will land. A gofer in the area of the predicted ball landing position is assigned, via wireless signals from a control system, to detect the landing position and collect the ball. The gofer visually detects the ball location upon landing, determines its position and moves to the ball location where the ball is then collected by the gofer. The gofer reports the ball position back to the control system and the score and/or ball landing location is updated to reflect the actual detected landing position. In this context the ball landing position is intended to refer to the final resting position of a ball after landing on the ground and may include some movement due to rolling on the ground.

Gofers automatically return as need to a docking station where the balls they have collected are unloaded, e.g., automatically, and the gofer's batteries are recharged. The control system is kept aware, e.g., via wireless signaling, of the number of balls collected by each gofer, the gofer's battery charge status and general operating condition. In the event of a low battery condition, a full or nearly full ball load and/or other issues that may require a return to the docking station, the gofer can be commanded to return to the docking stations and/or autonomously decided to return. The control system will deploy a replacement gofer to cover the area previously covered by the returning gofer thereby maintaining full coverage even in cases where an individual gofer may be removed from service. Since gofers are mobile and can take over servicing any area, the failure of one or more gofers does not interfere with overall system operation as the gofers are automatically taken out of service and a replacement gofer takes over responsibility for a given area. In this way system reliability does not suffer even when an individual gofer unit suffers a sensor or other failure or problem.

While in some systems a centralized controller is used, all or portions of the control functionality can be implemented in a distributed manner with the processors in one or more gofers acting as the control unit and/or with the processor of once gofer taking over as a master controller when the processor of another gofer is no longer available or capable of serving as a master in a distributed controller approach.

In some embodiments, the gofers include laser range finding sensors. The gofer is alerted to a possible incoming golf ball by the control system based on the flight path predicted by the sensors at the booth where a player tees off, e.g., hits the golf ball with the club. A camera on the gofer detects the actual resting position of the ball once it lands, determines the position using the laser range finder and the gofer's known position on the course and/or visual information in the image of the ball on the field and reports the information back to the control system which scores the player and/or triggers another action based on the reporting landing/resting place of the ball. In some embodiments different players are allocated different balls or golf balls with different patterns on them. This allows for visual identification of balls by the gofer and/or control system and association of individual ball and its resting location with a corresponding player using balls with the detect color or pattern. In this way balls can be, and sometimes are, matched to players without the need for RFID chips. In cases where range finding is used to determine a balls location, collection of the ball can occur after reporting of the balls location. In other embodiments the gofer collects a ball, captures a close up image as it is collected or at the collection site and then reports back the location at which the ball is located which will also be the location of the gofer at the time of collection.

The control system responds to the report of a ball landing or resting location by updating the score of the user to which the ball corresponds. The control system may also trigger some other actions such as a laser, light or smoke display in the area where the ball landed or some other area visible to the player. A laser light show is sometimes triggered and presented to highlight a particular score being reached or other achievement such a hole in one or hitting a target. Announcements with regard to the player's achievement, e.g., score or ball landing location, may be, and sometimes are, automatically made. In addition or alternatively a projector may be used to project up a visual sequence congratulating the user on his achievement whether that be good or bad or to make some other comment or display associated with the golf result detected by the gofer. In some embodiments light or projections onto a field of mist or smoke are made based on the detected landing result.

In various embodiments the system leverages artificial intelligence and dynamic targeting to determine scores, track and measure each ball and were it comes to rest for shot data information, scoring, prizes and/or to control the presentation of down range entertainment. In some embodiments visual awards such a winner screen or announcement and/or Jackpot hole in one award are displayed on a television or augmented reality mist screen either of which can, and in some embodiments do, serve as an award presentation screen. Downstream special effects such as bangs, award sounds, light flashes and/or a laser light show are triggered and presented in response to a user achievement, e.g., a user achieving a score or hitting a target with a ball. The player may be, and sometimes is, presented with an award, e.g., a physical trophy, sign or other item showing a particular achievement. In some embodiments the system includes one or more devices for implementing an action based on an achieved score. Such devices may and sometimes do include a laser light projector for generating a laser light show, a smoke generator for generating smoke, a score display screen or billboard for displaying achieved scores with an associated player or user identifier, an audio system including one or more speakers for making automated award or score announcements and/or an automated vending machine for automatically presenting trophies or other physical awards to a user achieving a score or other achievement.

An exemplary system, in accordance with some embodiments, comprises: a sensor located in a teeing booth; a control system coupled to said sensor, the control system including a control system processor configured to predict a ball landing location based on sensor information provided by said sensor; and a first mobile golf ball collecting vehicle and a wireless transmitter. An exemplary method, in accordance with some embodiments, comprises: operating a mobile cart to communicate ball landing information to a control device, said ball landing information providing information relating to a ball which was driven by a player; and operating the control device to update a score of the player based on the ball landing information. While various features discussed in the summary are used in some embodiments it should be appreciated that not all features are required or necessary for all embodiments and the mention of features in the summary should in no way be interpreted as implying that the feature is necessary or critical for all embodiments. Numerous additional features and embodiments are discussed in the detailed description which follows. Numerous additional benefits will be discussed in the detailed description which follows.

### BRIEF DESCRIPTION OF THE FIGURES

FIG. 1 is a drawing of an exemplary golf practice facility/system including automated ball tracking and automated ball retrieval in accordance with an exemplary embodiment.

FIG. 2 a drawing of an exemplary gofer, which is mobile golf ball retrieval unit and/or mobile target, in accordance with an exemplary embodiment.

FIG. 3 is a drawing illustrating an exemplary assembly of software components and exemplary data/information included in the memory of an exemplary gofer in accordance with an exemplary embodiment.

FIG. 4 is a drawing of an exemplary tee off booth in accordance with an exemplary embodiment.

FIG. 5 is a drawing illustrating an exemplary assembly of software components and exemplary data/information included in the memory of an exemplary tee off booth in accordance with an exemplary embodiment.

FIG. 6 is a drawing of an exemplary central processing, control and communications station in accordance with an exemplary embodiment.

FIG. 7 is a drawing illustrating an exemplary assembly of software components and exemplary data/information included in the memory of an exemplary tee off booth in accordance with an exemplary embodiment.

FIG. 8 is a drawing of an exemplary docking station in accordance with an exemplary embodiment.

FIG. 9 is a drawing illustrating an exemplary assembly of software components and exemplary data/information included in the memory of an exemplary docking station in accordance with an exemplary embodiment.

FIG. 10 is a drawing of the exemplary golf practice facility of FIG. 1 which further illustrates exemplary gofers and exemplary mobile targets in accordance with an exemplary embodiment.

FIG. 11 is a drawing of exemplary identifiable golf balls in accordance with various exemplary embodiments.

FIG. 12A is a first part of a flowchart of an exemplary method of operating a system which tracks and recovers golf balls, e.g., in a practice range, in accordance with an exemplary embodiment.

FIG. 12B is a second part of a flowchart of an exemplary method of operating a system which tracks and recovers golf balls, e.g., in a practice range, in accordance with an exemplary embodiment.

FIG. 12C is a third part of a flowchart of an exemplary method of operating a system which tracks and recovers golf balls, e.g., in a practice range, in accordance with an exemplary embodiment.

FIG. 12 comprises the combination of FIG. 12A, FIG. 12B and FIG. 12C.

### DETAILED DESCRIPTION

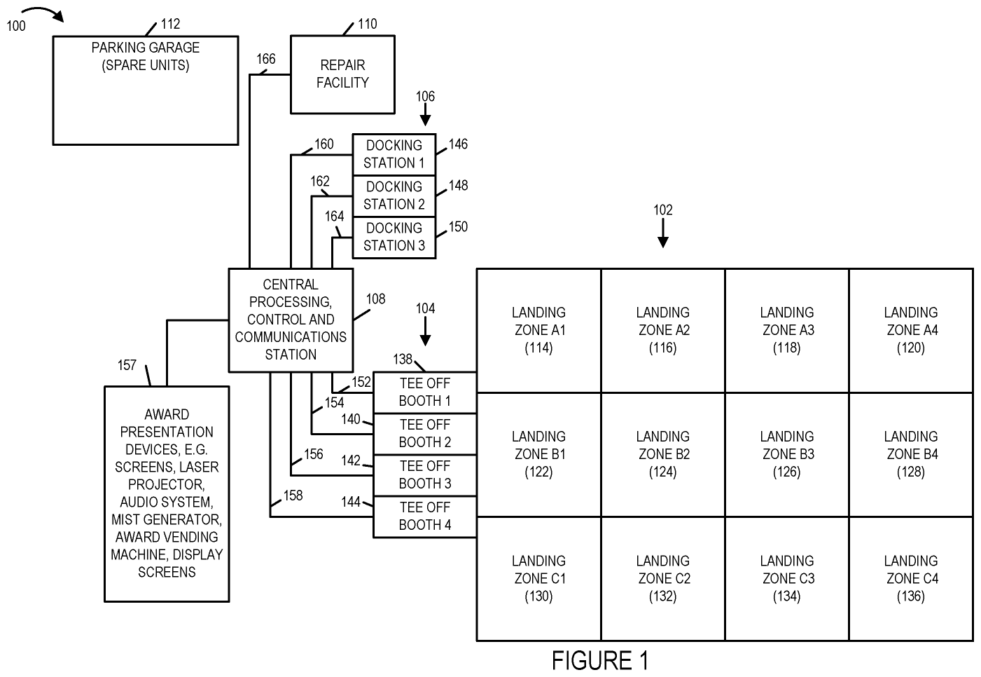

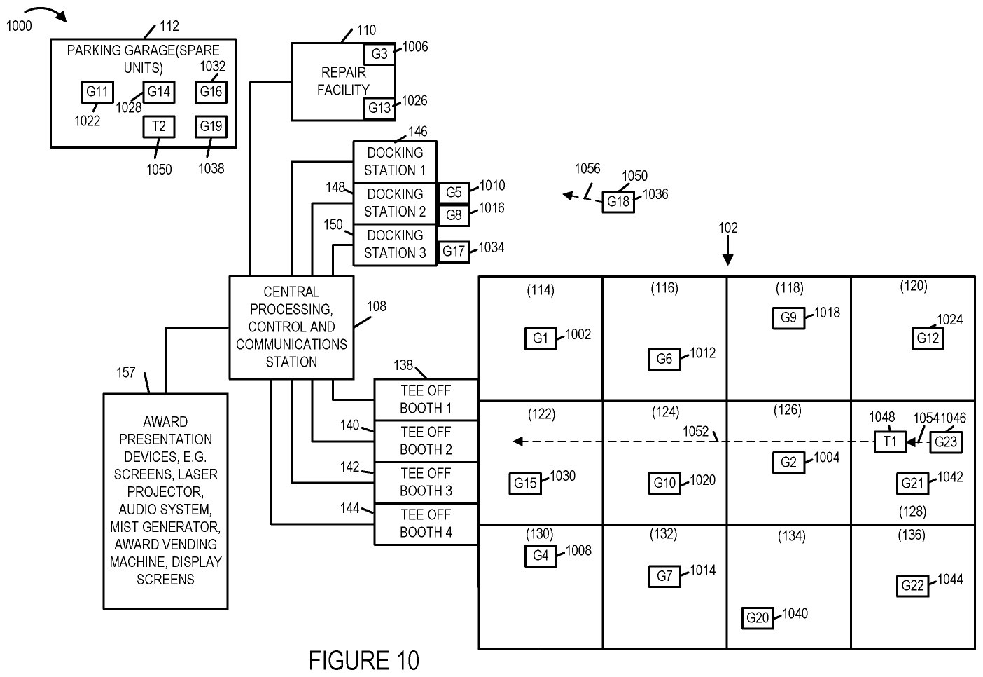

FIG. 1 is a drawing of an exemplary golf practice facility/system 100 including automated ball tracking and automated ball retrieval in accordance with an exemplary embodiment. Exemplary golf practice facility 100 includes a golf range 102, a plurality of tee off booths 104, a plurality of docking stations 106, a central processing, control and communications station 108, a repair facility 1102 and a parking garage 112. Golf range 102 includes a plurality of landing zones (landing zone A1 114, landing zone A2 116, landing zone A3 118, landing zone A4 120, landing zone B1 122, landing zone B2 124, landing zone B3 126, landing zone B4 128, landing zone C1 130, landing zone C2 132, landing zone C3 134, landing zone C4 136). In various embodiment the central control system 108 is coupled to and controls one or more award presentation devices 157 which may be located at a common location or distributed throughout a site with some being located downrange and others being located near the tee booths and/or a club house arear. Award presentation devices include, e.g., display screens in the form of smoke, mist or LCD display screens, a laser and/or light projector for making visual presentations of awards or displays, an audio system for making announcements and/or sounds, a mist generator, a smoke generator, and/or an award vending machine which is used to automatically present trophies or other awards who identify themselves using a pin or other identifier to the vending machine to identify which user is accessing the vending machine and seeking a physical award such as a trophy due to an achieved score or other achievement such as hitting a target with a ball. Connections between the control system and award devices may be and sometimes are wireless connections. The system includes a plurality of tee off booths includes tee off booth 1 138, tee off booth 2 140, tee off booth 3 142 and tee off booth 4 144. Each of the tee off booths (138, 140, 142, 144) is coupled to the central processing, control and communications station 108 via a communications link (152, 154, 156, 158), respectively. The plurality of docking stations 106 includes docking station 1 146, docking station 2 162, and docking station 3 150. Each of the docking stations (146, 148, 150) is coupled to the central processing, control and communications station 108 via a communications link (160, 162, 164), respectively. Repair facility 110 is coupled to the central processing, control and communications station 108 via a communications link 110, e.g., for reporting which vehicles are at the repair facility and status of the vehicles at the repair facility. Golf practice facility/system 100 further includes a plurality of mobile golf ball retrieval units and mobile targets, which are shown in FIG. 10. The central processing, control and communications station 108 is sometimes implemented using a microprocessor including a central processing unit (CPU, memory, input/output interface. In some embodiments the processor of the controller 108 controls the devices in the system shown in FIG. 1 to operated in accordance with the methods and steps described in the present application.

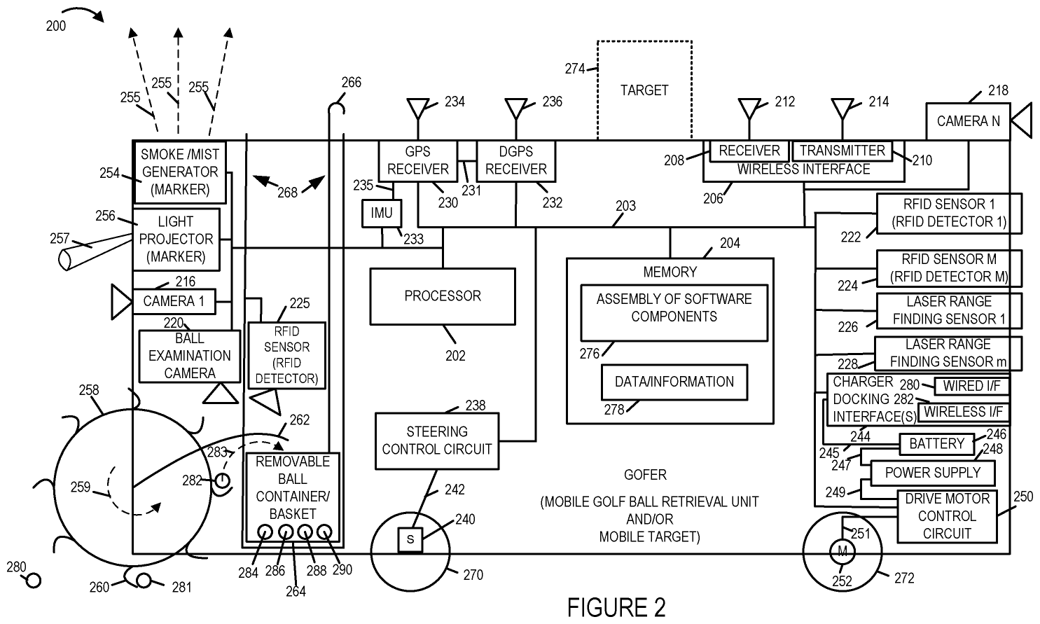

FIG. 2 a drawing of an exemplary gofer 200, which is mobile golf ball retrieval unit and/or mobile target, in accordance with an exemplary embodiment. Exemplary gofer 200 is sometimes referred to as a mobile cart. Exemplary gofer 200 is, e.g. any of the gofers (G1 1002, G2 1004, G3 1006, G4 1008, G5 1010, G6 1012, G7 1014, G8 1016, G9 1018, G10 1020, G11 1022, G12 1024, G13 1026, G14 1028, G15 1030, G16, 1032, G17 1034, G18 1036, G19 1038, G20 1040, G21 1042, G22 1044, G23 1046) of system 100 which are shown in FIG. 10. In some embodiments targets T1 1048 and T2 1050 (also shown in FIG. 10) are gofers for which the ball retrieval, e.g., ball collection, functionality is omitted or deactivated, and which are serving as targets, e.g., aiming points for the golfer. Exemplary gofer 200 is, e.g., a mobile unmanned autonomous or semi-autonomous vehicle, e.g., a battery powered terrestrial vehicle. Gofer 200 includes wheels 270, 272, a steering mechanism 240 for redirecting the direction of the gofer 200, and an electric motor 252 for propelling the vehicle. Gofer 200 further includes a rotating drum 258 with ball capture arms 260 for scooping up golf balls 280, 281, 282, 284, 286, 288, 290, and throwing the golf balls against deflection blade 262, which deflects golf balls in removable ball container/basket 264. In some embodiments, device 262 is or includes a rake or comb to direct balls into the container basket and/or to prevent balls for exiting the ball collection area. In some embodiments, the ball pick-up apparatus includes rollers and/or brushes in addition to or in place of ball capture arms 260. Drum 258 rotation direction is shown by arrow 259. Exemplary golf ball 282 is thrown along path 283 into basket 264. Removal ball container/basket 290 fits within slot 268 and can be pulled out and removed by hooks 266 attached to container/basket 286, e.g., while gofer is at a docking station.

Exemplary golf ball retrieval/recovery apparatus (258, 260, 262) is an exemplary mechanism for picking up golf balls on the field; however, other golf ball retrieval/recovery apparatus are used in some embodiments of gofer 200, e.g. a mechanism while includes a rotating apparatus which rotates about a vertical axis, a mechanism which scoops up balls in a cow catcher fashion, a mechanism which drags a rake or comb, a mechanism which uses capture blades which funnels or direct balls in a particular direction, etc.

In some embodiments gofer 200 includes a target 274, e.g. raised flag with an identification number, pole, light, etc., intended to be visible to a golfer in a driving range booth, and to identify an aiming point on the range for the golfer.

Gofer 200 further includes a processor 202, e.g., a CPU, memory 204, a wireless interface 206, a plurality of cameras (camera 1 216, . . . , camera N 218), a ball examination camera 220, a plurality of RFID sensors (RFID sensor 1 22, e.g. RFID detector, . . . , RFID sensor M 224, e.g., RFID detector M), and internal RFID sensor 225, a plurality of laser range finding sensors (laser range finding sensor 1 226, laser range finding sensor m 228), a global position satellite (GPS) receiver 230, a differential GPS (DGPS) receiver 232 for enhancing the accuracy of GPS solution, an inertial measurement unit (IMU), e.g., an IMU on a chip including gyroscopes and accelerometers, a steering control circuit 238, charging docking interface(s) 244 including a wired charging interface 280 and/or a wireless charging interface 282, a rechargeable battery 246, a power supply 248, a drive motor circuit 250, a smoke/mist generator 254, and a light projector 256 coupled together via bus 203 over which the various devices may interchange data and information.

Memory 204 includes an assembly of software components 276, e.g., assembly of software routines, e.g. a set of software routines for controlling operation of the gofer 200, and data/information 278. The wireless interface 206 includes a wireless receiver 208 and a wireless transmitter 210. The wireless receiver 208 is coupled to a receive antenna 212 via which the gofer 200 may, and sometimes does, receives wireless signals, e.g. wireless signals from a central processing, control and communications device 108 or 600, communicating information and/or commands to the gofer 200, e.g., a command to search of balls in a particular zone, a command to follow a target, a message communicating an estimated location of a recently driven golf ball and/or information to identify the ball, a command to attempt to determine a final location of a driven ball based on a communicated estimated landing position of the golf ball, a command to report to a particular zone, e.g. to replace another gofer, etc. The wireless transmitter 210 is coupled to transmit antenna 214, via which the gofer may, and sometimes does, transmits signals, e.g., wireless signals to a control and communications device 108, communicating, reports, messages, photographs, e.g., images of a golf ball, and/or other information, e.g. golf ball search results, ball landing reports, gofer status reports, scoring reports, captured images, ball identification information, e.g. an RFID value, etc.

GPS receiver 230 is coupled to GPS antenna 234, via which the gofer 200 receives GPS signals from GPS satellite transmitters, and based on said received signals determines a GPS estimated position and velocity of the gofer 200. The DGPS receiver 232 is coupled to DGPS receiver 232, via which the gofer 200 receives DGPS signals from a satellite based or terrestrial based DGPS transmitter. Corrections are determined based on the received DGPS signals and sent to the GPS receiver, via link 231, to increase accuracy of the position and velocity determinations. The IMU 233, which is coupled to the GPS receiver 230, provides information used to aid navigation determinations, and is especially useful when GPS signal is lost or degraded, e.g., due to obstructions between the GPS satellites and the gofer. Information from GPS receiver 230, DGPS receiver 232, IMU 233, is used by a navigation routine in gofer 200 to direct the gofer to a desired location, e.g. an assigned landing zone, a docking station, an estimated landing position of a golf ball, a detected location of a golf ball on the field, etc.

RFID sensors (222, . . . , 224) detect RFID chip embedded golf balls and report detected ID numbers. Laser range finding sensors (226, . . . , 228) measured distance to objects, e.g., golf balls, target vehicles, known location position markers, etc.

Steering control circuit 238 is coupled to steering mechanism 240, via steering link and/or bus 242, and is used for controlling the direction of gofer 200, e.g. toward a desired location or object, e.g., an estimated landing position of a ball, a visually detected ball which has landed, a docking station, a repair station, a mobile target which the gofer is following, etc. Drive motor control circuit 250 controls motor 252, via applying power and/or sending control signals over bus 252 to motor 252 to control the rate motor turn speed and direction to cause the gofer to move in forward or reverse at a desired speed.

Charger docking interface 244 is used to electrically the gofer 200 to a power connection of a docking station to recharge battery 246. Battery 246 is coupled to power supply 248 which generates various AC and DC power supply voltages used to be used by the various components of the gofer, e.g. DC voltage levels used by the processor memory, receivers, cameras, etc., and an AC voltage used to drive the motor 252. Charging docking interface 244 is coupled to battery 246 via bus 245 over which power is supply and monitoring signals are transmitted. Power supply 248 is coupled to derive motor control circuit 250 via power bus 249.

Cameras (camera 1 216, . . . , camera N 218) captured images of the field includes images of golf balls which are in flight, which have landed and which have stopped moving. Captured images of golf balls may be, and sometimes are, communicated to a control system via wireless transmitter 210, e.g., with a time tag and a position tag, e.g., GPS coordinates corresponding to the ball.

Ball examination camera 220 captures images of retrieved balls which are being placed in the ball container basket 264. In some embodiments, ball examination camera 220 captures an image of a ball lying on the field, e.g. just prior to being retrieved by the gofer. In various embodiments, the close up image of the ball captured by ball examination camera 220 is used to identify the ball, e.g., via color, pattern, and/or symbol and to associate the ball with a particular golfer. In some embodiments, the association is performed within the gofer 200 and communicated to the control system, e.g., central processing, control and communications station 108. Alternatively, in some other embodiments, image(s) of the retrieved ball are sent via wireless transmitter 210 to the control system, e.g., central processing, control and communications station 108, for the control system to make the identification and association with a golfer.

RFID sensors (222, . . . , 224) detected RFID chips embedded within golf balls which are in the vicinity of gofer 200, e.g., in flight, moving on the field or at rest on the field. Internal RFID sensor 225 is used to detect the RFID of an RFID chip of a particular ball which has just been retrieved or is in the process of being retrieved and stored. In some embodiments, a golf ball can be matched to a particular golfer based on RFID values. In some embodiments, the gofer 200 performs the matching, while in other embodiments, the gofer communicates, via wireless transmitter 210, the RFID value of a detected or captured ball to the control system which performs the matching to a particular golfer. In some embodiments, the gofer 200 searches for a particular ball based on a RFID value which has been communicated from the control system to the gofer 200, and received via wireless receiver 208.

Laser range finding sensor (226, 228) are used to determine the distance from the gofer location to the location of a golf ball, e.g. a golf ball in a captured image.

Smoke/mist generator 254 generates and emits smoke or mist 255, e.g. in response to a command from the control system, e.g., marking the location on the field of a detected golf ball of interest, e.g., marking the final resting location (stop location) of a detected golf ball of interest. Light projector marker 256, generates and beams light 256 e.g. in response to a command from the control system, e.g., marking the location on the field of a detected golf ball of interest, e.g., marking the final resting location (stop location) of a detected golf ball of interest. The generated smoke or mist or beam light marking is intended to be viewable by the golfer in the teeing booth who drove the ball, e.g. either directly visually or visually to the golfer via a captured image of the field presented to the golfer on a display in the teeing booth.

Charging docking interface(s) 244 includes one or both of: a wired interface 280 for charging the battery 246 via a direct hardwire connection to a charger which supplies energy and a wireless interface 282 for charging the battery 246 via a wireless connection to a charger which supplies energy. The charger docking interface(s) 244 is coupled to the battery 246. The battery 246 is coupled to the power supply which generates AC and DC supply voltages to be used by the gofer 200. Bus 249 is coupled to drive motor control circuit 250, which is coupled via link 251 to electric motor 252, which is used to drive wheels 272 and move the vehicle 200.

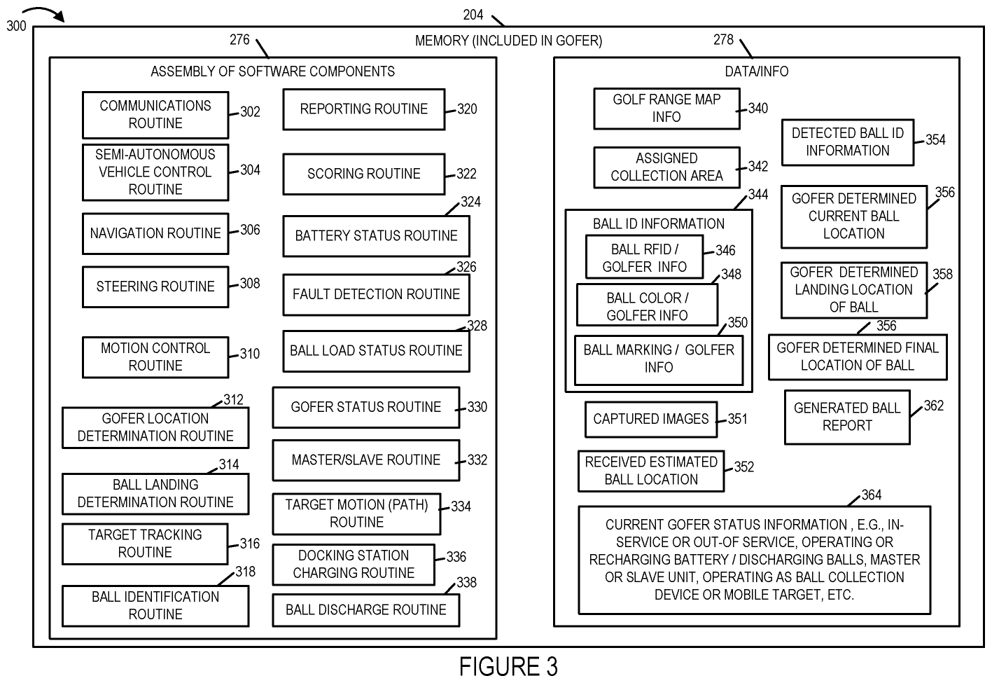

FIG. 3 is a drawing 300 illustrating an exemplary assembly of software components 276 and exemplary data/information 278 included in the memory 204 of an exemplary gofer 200, in accordance with an exemplary embodiment. Assembly of software components 276 includes a communications routine 302, a semi-autonomous vehicle control routine 304, a navigation routine 306, a steering routine 308, a motion control routine 310, a gofer location determination routine 312, a ball landing determination routine 314, a target tracing routine 316, a ball identification routine 318, a reporting routine 320, a coring routine 322, a battery status routine 324, a fault detection routine 326, a ball load status routine 328, a gofer status routine 330, a master/slave routine 332, a target motion (path) routine 334, a docking station charging routine 336, and a ball discharge routine 338. Communications routine 302 controls the wireless interface 206 including wireless receiver 208 and wireless transmitter 210 to receive and send wireless signals, e.g. to a controller, e.g. central processing, control and communications station 108, said wireless signals communicating, e.g., commands, reports, and/or sensor information. Semi-autonomous vehicle control routine 304 control gofer 200, via commands to steering control circuit 238 and drive motor control circuit 250, to move and steer the gofer 200, e.g., in accordance with navigation data. Navigation routine 306 uses information from GPS receiver 230, DGPS receiver 232, IMU 233, laser range finding sensors 226, 228, as well as stored golf map range information 340 to determine a route from the present location of the gofer 200 to a desired location, e.g., a position of a detected ball of interest on the field, or the position of a docking station or a repair facility. Steering routine 308 controls the steering control circuit 238 to steer the gofer, e.g. point the gofer in a desired direction. Motion control routine 310 controls the drive motor control circuit 250 to cause the motor 251 to move the vehicle in forward or reverse at a desired speed level. Gofer location determination routine 312 uses information from GPS receiver 230, DGPS receiver 232, IMU 233, captured images, and from laser range finding sensors (226, 228) to determine the current location of gofer 200. Ball landing determination routine 314 determines the location of a ball based on the determined location of the gofer 200, laser range sensor 226, 228 results, captured images, and/or a detected RFID corresponding to the ball. Target tracking routine 316 controls the gofer to follow (shadow) a designated mobile target to which it has been assigned. Target tracking routine 316 also causes the gofer 200 to function in the capacity of a mobile target, e.g. following a specified target path, when the gofer has been assigned to function as a mobile target. Ball identification routine 318 uses captured sensor information, e.g. RFID signals, or captured images, to identify a ball based on RFID or other ball ID information, e.g. ball cover markings, pattern and/or color.

Reporting routine 320 generates reports, e.g., detected ball reports, scoring reports, status reports, etc. to be sent, e.g., to a controller such as central processing control and communications station 108. Scoring routine 322 generates scores and/or updates scores, e.g., based on distance of the driven ball and/or accuracy of the driven ball, e.g. with regard to a target location. Battery status routine 324 monitors the status of battery 246 and determines when recharging or battery replacement is needed. Fault detection routine 326 performs various internal tests on gofer 200 using built in test equipment (BITE), e.g. monitoring the pass/fail status with regard to different systems, devices, components and/or sub-systems (communications, drive, steering, navigation, sensors, etc.). Ball load status routine 328 monitors how full the removable ball container/basket is, e.g. counting the number of recovered balls since last discharge or monitoring the level within the container/basket. Gofer status routine 330 determines current status of the gofer 200 with regard to a plurality of different criteria, e.g. i) fully operational/usable but in a degraded state or degraded mode/critical failure and unusable, ii) current assignment (assigned as a gofer to a particular landing zone, assigned as a gofer to follow a target, assigned as a target, currently unassigned and waiting in parking garage as a spare), iii) current operation (in search of a driven ball, located and recovering a ball, reporting recovery), iv) moving or stationary, v) in operation or being serviced (battery recharge/ball discharge), etc. Master/slave routine 332, controls the gofer 200 to operate as a master gofer or a slave gofer, e.g., in response to a command from a controller, in embodiments implementing a master/slave configuration with regard to gofers. In some such embodiments, a master gofer, under control of a controller, e.g. station 108, directs and/or controls one or more slave gofers. Target motion (path) routine 334 controls the gofer 200 to follow a particular path when acting as a target. Docking station charging routine 336 controls the gofer 200 to interface and communicate with a charger at a docking station. Ball discharge routine 338 controls the gofer 200 to configure, e.g., unlock the removable ball container, open an access panel, etc. and/or assist in the ball discharge while at a docking station.

Data/information 378 includes golf range map information 340, an assigned collection area 343, ball identification (ID) information 344 including one or more or all of: ball RFID/golfer information 346, ball color/golfer information 348, and ball marking/golfer information 350. Data/information 278 further includes captured images 351, received estimated ball location 352, detected ball ID information 354, gofer determined current ball location 356, gofer determined landing location of the ball 356, gofer determined final ball location 358, gofer determined final ball location 360, and a generated ball report 362. Data/information 278 further includes current gofer status information 364, e.g. in-service or out-of-service, operating on the field or recharging the battery and/or discharging captured balls at a docking station, operating as a master unit or operating as a slave unit in embodiments in which there are master and slave gofers in the system, operating as a ball collection device or operating as a mobile target, operating as ball collection device assigned to a particular area or operating as a ball collection device assigned to follow a particular moving target, etc.

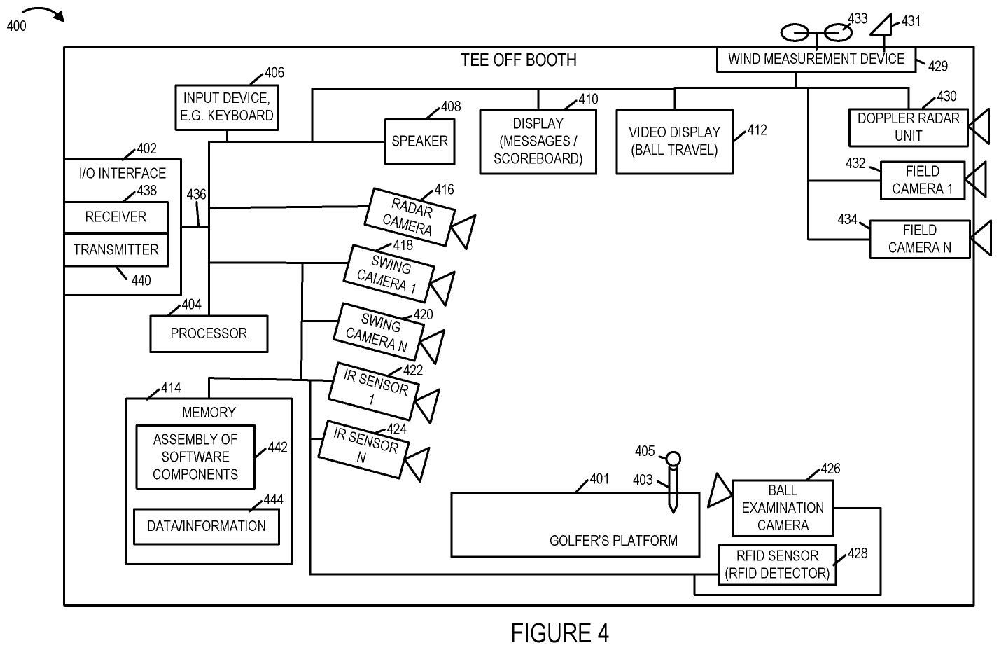

FIG. 4 is a drawing of an exemplary tee off booth 400, sometimes referred to as a teeing booth or bay, in accordance with an exemplary embodiment. Exemplary tee off booth 400 is, e.g., any of the tee off booths (138, 140, 142, 144) of system 100 of FIG. 1. Exemplary tee off booth 400 includes a golfer's platform 410, a tee 403 and a plurality of identifiable golf balls including exemplary golf ball 405, which is currently on tee 403. Tee off booth 400 further includes an I/O interface 402, a processor 404, e.g., a CPU, a input device, e.g. a keyboard 406, a speaker 408, a display 410, a video display 412, memory 414, a radar camera 416, a plurality of swing cameras (swing camera 1 418, . . . , swing camera N 420), a plurality of infrared (IR) sensors (IR sensor 1 422, . . . , IR sensor N 424), a ball examination camera 426, a RFID sensor (RFID detector) 428, a wind measurement device 429, a Doppler radar unit 430, and a plurality of field cameras (field camera 1 432, . . . , field camera N 434) coupled together via a bus 436 over which the various devices may interchange data and information.

I/O interface 402 includes a receiver 438 and transmitter 440. I/O interface 402 couples the tee off booth 400 to other devices and/or systems, e.g., via a wired or optical communications link. For example I/O interface 402 couples tee off booth 400 to central processing, control and communications station 108. Memory 414 includes assembly of software components 442, e.g., an assembly of software routines for controlling operation of tee off booth 400, and data/information 444.

Wind measurement device 429 includes a wind direction sensor 431, e.g., a wind vane sensor, and a wind speed sensor 433. In various embodiments, wind direction and wind speed, obtained from sensors 431, 433 are used as inputs, e.g., for determining corrections or adjustments, in estimating a golf ball's trajectory.

Ball examination camera 426 captures an image of the golf ball 405, which is about to be driven. In various embodiments, information from the captured image, e.g. ball color, ball markings, ball cover pattern, etc. is used to identify the ball 405 and associated it with a particular golfer, e.g. the golfer in booth 400 about to drive the ball 405. RFID sensor 428 detects the RFID value of the RFID chip embedded in golf ball 405, for embodiments, in which golf ball 405 includes an RFID chip. The detected RFID value is used to associate the ball 405 with a particular golfer, e.g. the golfer in booth 400 about to drive the ball 405.

Radar camera 416 is used to measure the speed of the ball as it is accelerated and as it leaves the club and starts on its trajectory. Swing cameras (418, . . . 420) are used to capture images of the ball as it is being driven during the swing and as it begins on its trajectory. IR sensors (422, . . . 424) are used to track the ball as it is being driven during the swing and as it begins on its trajectory. Sensors (416, 418, 420, 422, 424) are used to determine, e.g., by processor 404 in tee off booth 400 or by a processor 696 in the control station 600 or 108, an initial launch position, speed and direction (velocity vector), and spin rate for golf ball 405. Doppler radar 430 is used to track driven balls, e.g., golf ball 405, as it proceeds through the air of the range over the field. Field cameras 432, 436 are used to capture images of driven balls, e.g., ball 405, as it proceeds over the field, lands and rolls on the field.

Input device 406, e.g. a keyboard, is used to: receive ID information, e.g., a name, a club membership ID number, an access code, etc., identifying the golfer in booth 400, receive information indicating the type of practice to be performed, e.g. drive for maximum range, or drive to attempt to hit a target, e.g. a target which moves along a predetermined of specified path.

Speaker 408 broadcasts messages/instructions/results to the golfer. Display 410 displays messages, results, and/or scores to the golfer. Video display 412 displays images of the driven ball, e.g. including close-ups of captured images, replays of a driven ball along its trajectory, etc.

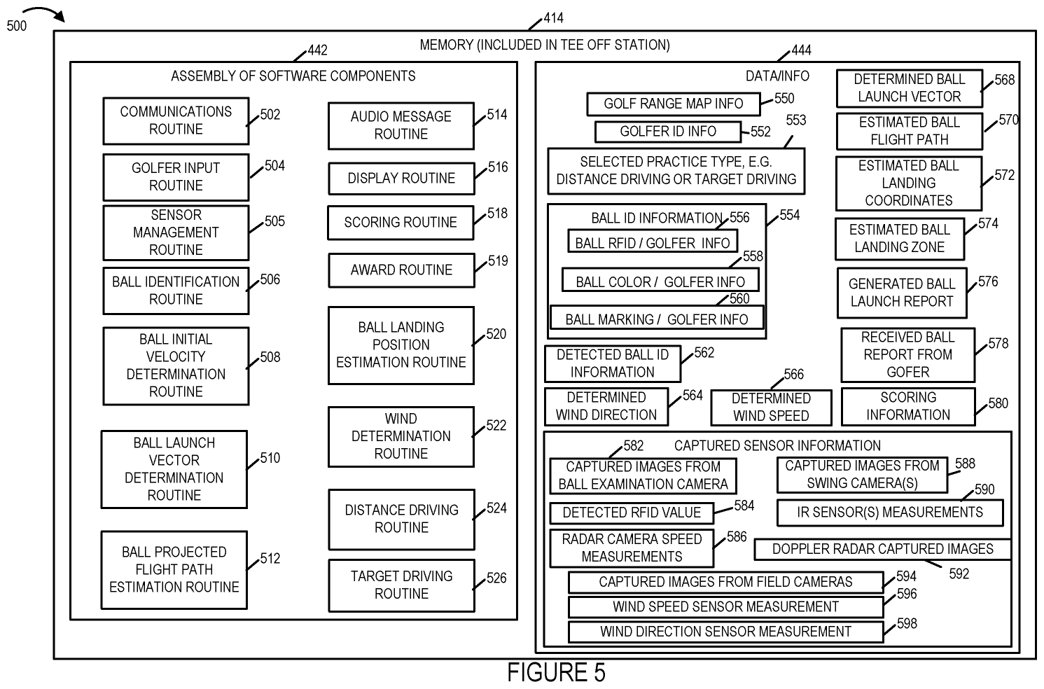

FIG. 5 is a drawing 500 illustrating an exemplary assembly of software components 442 and exemplary data/information 444 included in the memory 414 of an exemplary tee off booth 400 in accordance with an exemplary embodiment. Assembly of components 442 includes a communications routine 502, a golfer input routine 504, a sensor management routine 505, a ball identification routine 506, a ball initial velocity determination routine 508, a ball launch vector determination routine 510, a ball projected flight path estimation routine 512, an audio message routine 514, a display routine 516, a scoring routine 516, an award routine 519, a ball landing position estimation routine 520, a wind determination routine 522, a distance driving routine 524, and a target driving routine 526. Communications routine 502 controls the I/O interface including the receiver 438 and transmitter 440 to receive/send signals from/to a controller, e.g. station 108, said signals communicating, e.g., messages, reports, commands, raw or processed sensor data, images, indications, determinations, etc. Golfer input routine 504 receives, processes and/or stores input from the golfer using the tee off booth 400, e.g. golfer name, golfer ID, type of practice, e.g. distance driving or target driving, etc. Sensor management routine 505 manages the various sensors (ball examination camera 436, RFID sensor 428, radar camera 416, swing cameras 418, 420, IR sensors 422, 424, Doppler radar unit 430, field cameras 432, 434, wind speed device 433, wind direction device 431) in the tee off booth 400, e.g. activating/deactivating sensors, receiving sensor outputs of activated sensors, storing sensor data, processing, e.g., filtering and/or evaluating sensor data, and generating sensor reports for communications to a controller, e.g. station 108. Ball identification routine 506 identifies a ball, e.g. a ball about to be teed off, e.g. based on detected RFID signal or a captured image and using stored ball ID information 554. Ball initial velocity determination routine 508 determines an initial velocity, e.g. speed and direction, for a driven ball based on captured sensor information, e.g. images from swing cameras, IR sensor data, and/or radar measurements. Ball launch vector determination routine 510 determines a ball launch vector, e.g. a vector with an end point at the launch point where the ball leaves the club, with the determined initial speed and with the determined initial direction. Ball projected flight path estimation routine 512 estimates a flight path for the driven ball based on the determined ball launch vector, determined wind speed, determined wind direction, and in some embodiment, captured images from cameras (432, 434) monitoring the air space above the field and/or from captured radar images/data from Doppler radar unit 430. Ball landing position estimation routine 520 estimates the landing coordinates of the driven ball, e.g. based on the estimated projected flight path, and/or estimates the coordinates on the field where the ball is expected to come to rest, e.g. based on the estimated speed and angle and which the ball hits the field and the current field conditions. Wind determination routine 522 determines the wind speed and/or wind direction based on sensor data from wind sensors (431, 433) of wind measurement device 429. Audio message routine 514 generates audio messages, e.g. instruction, results, scores, etc. which are intended for the golfer in booth 400. Display routine 516 controls the display 410 to display message and/or scores to the golfer. Display routine 516 also controls video display 412 to display video of the ball travel including user requested replays, close-up, etc. Scoring routine 518 determines and/or displays scores for the golfer in booth 400. Award routine 519 control awards (e.g., physical, audio and/or light based awards) to be assigned to and/or presented to the golfer, e.g. in response to a score over a predetermined limit, a ball hitting a target or landing in a particular area or some other condition used to control triggering of an award. Distance driving routine 524 configures the booth 400 and its sensors, in response to a user selection of distance driving practice to operate to support distance driving, and generates a message to be sent to the controller, e.g. control station 108, to control the system for distance driving practice with regard to the golfer. Target driving routine 526 configures the booth 400 and its sensors, in response to a user selection of target driving practice to operate to support target driving, and generates a message to be sent to the controller, e.g. control station 108, to control the system for target driving practice with regard to the golfer. In various embodiments, target driving involves the controller, e.g. control station 108, controlling a selected mobile target and a selected gofer to follow the moving target and collect balls. Different menus and different instruction are presented to the golfer as a function of the whether the golfer selected target driving or distance driving.

Data/information 444 includes golf range map information 550, golfer ID information 552, a selected practice type, e.g. distance driving or target driving, ball identification (ID) information 554. Ball ID information 554 includes ball RFID/golfer information, e.g. information mapping a set of RFID values, e.g., RFID value corresponding to an RFID chip in a golf ball, to a particular golfer, ball color/golfer information 558, e.g., information mapping different color golf balls to different golfers, and ball marking/golfer information 580, e.g., information mapping different golf ball cover patterns and/or symbols to different golfers. Data/information 444 further includes detected ball ID information 562, a determined wind direction 564, a determined wind speed 566, a determined ball launch vector 568, an estimated ball flight path, estimated ball landing coordinates 572, an estimated or predicted ball landing zone 574, a generated ball launch report 576, a received ball report from a gofer 578, scoring information 580, and captured sensor information 580. Captured sensor information 580 includes captured images 582 from ball examination camera, a detected RFID value 584 from an RFID chip embedded in a golf ball, speed measurements 586 from a radar camera, captured images 588 from one or more swing cameras, IR sensor measurements 590, Doppler radar captured images 592, captured images 594 from the field cameras, a wind speed measurement 596 and a wind direction measurement 598. In some embodiments, sensor measurements are processed in booth 400, e.g. by processor 404. In other embodiments, sensor measurements are forwarded to a control system, e.g., central processing, control and communications station 108 or 600 for processing.

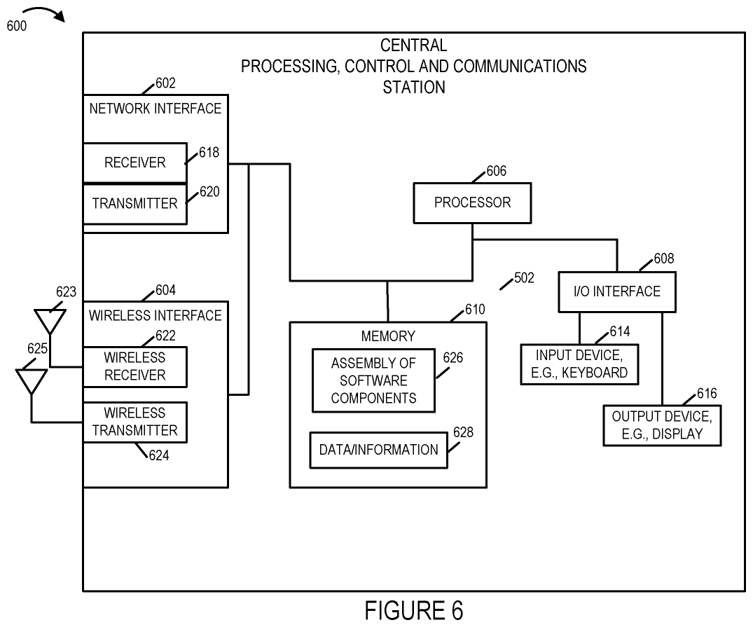

FIG. 6 is a drawing of an exemplary central processing, control and communications station 600 in accordance with an exemplary embodiment. Exemplary central processing, control and communications station 600 is, e.g., central processing, control and communications station 108 of system 100 of FIG. 1. Central processing, control and communications station 600 includes a network interface 602, a wireless interface 604, a processor 606, e.g., a CPU, I/O interface 608 and memory 610 coupled together via a bus 612 over which the various elements may interchange data and information. Network interface 602 includes a receiver 618, via which station 600 receives messages including, e.g., reports conveying processed, determined, estimated and/or projected information, e.g., a golf ball report corresponding to a detected driven ball, a projected flight path for a golf ball, an estimated landing zone, score information, etc., and messages communicating raw, filtered, and/or processed sensor data including, e.g., captured images, RFID values, velocity measurements, radar measurements, etc, with the data to be processed by the station 600, and a transmitter 620 which transmits commands, control information, etc. Network interface 602, e.g., a wired or fiber optic interface couples the station 600 to tee off booths, e.g., tee off booths (138, 140, 142, 144, 400) docking stations, e.g., docking stations (146, 148, 150, 800) and a repair facility, e.g., repair facility 110. Wireless interface 604 includes a wireless receiver 622 coupled to receive antenna 623 and a wireless transmitter 624 coupled to transmit antenna 625. Exemplary signals transmitted by wireless transmitter 624 includes, e.g. a command to a gofer to patrol and retrieve golf balls in a particular designated landing zone or zone, a command to a gofer to follow a moving target and collect golf balls driven at the target, a command to a moving target to follow a particular path over the range, a command to a gofer to report to a landing zone to replace another gofer which needs to discharge its collected balls or recharge its batteries, a report to a gofer regarding a driven ball expected to land or to have recently landed in the landing zone corresponding to the gofer, a command to a gofer to mark the impact or final resting location with a light beam, smoke or mist, etc. Exemplary signals received by wireless receiver 622 includes, e.g., a report from a gofer corresponding to a detected or recovered golf ball, signals conveying captured images, detected ball identification information, e.g., an RFID value or other ball ID information, ball impact location, ball final resting location, gofer status report information, e.g. battery power level, number of balls recovered, current position of gofer, current fail/pass status of built in test equipment (BITE) results, etc.

Central processing, control and communications station 600 further includes an input device, e.g., a keyboard and an output device, e.g., a display 616 coupled to I/O interface 608. Input device 614 and output device 616 are used by a system administrator or monitoring personnel to configure or modify the system 100 and/or to monitor ongoing operations and/or identify and/or respond to problems. Memory 610 includes assembly of software components 626, e.g., an assembly of routines used to control operation of station 600 and system 100 and to process received information, e.g., from processors and/or sensors in the tee off stations, gofers, targets, and docking stations.

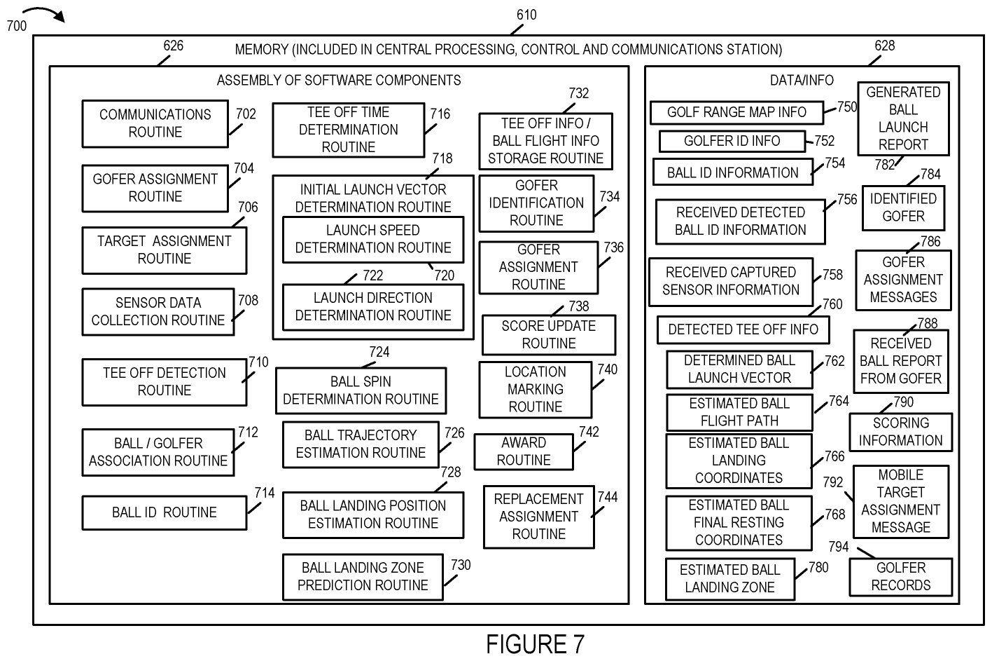

FIG. 7 is a drawing 700 illustrating an exemplary assembly of software components 626 and exemplary data/information 628 included in the memory 610 of an exemplary central processing, control and communications station 600 in accordance with an exemplary embodiment. Assembly of components 626 includes a communications routine 702, a gofer assignment routine 704, a target assignment routine 706, a sensor data collection routine, a tee off detection routine 710, a ball/golfer association routine 712, a ball ID routine 714, a tee off time determination routine 716, and an initial launch vector determination routine 718. Initial launch vector determination routine 718 includes a launch speed determination routine 720 and a launch direction determination routine 722. Assembly of components 626 further includes a ball spin determination routine 724, a ball trajectory estimation routine 726, a ball landing position estimation routine 728, a ball landing zone prediction routine 730, a tee off information/ball flight storage routine 732, a gofer identification routine 734, a gofer assignment routine 736, a score update routine 738, a location marking routine 740, and award routine 742, and a replacement assignment routine 744.

Communications routine 702 controls the network interface 602 including receiver 618 and transmitter 620 to communicate with other devices/subsystems in the system, e.g. tee off booths 138, 140, 142, 144, docking stations 146, 148, 150, and repair facility 110, e.g., receiving and/or sending messages, commands, sensor data, determinations, results, reports, etc. Communications routine 702 also controls the wireless interface 604 including wireless receiver 622 and wireless transmitter 624 to communicate with gofers and mobile targets and/or other devices including a wireless interface, e.g., receiving and/or sending messages, commands, sensor data, determinations, results, reports, etc. via wireless signaling. Gofer assignment routine 704 assigns selected gofers to particular landing zones on the field to patrol, search for golf balls, recover golf balls and report recovered gold balls. FIG. 10 illustrates an example in which a gofer has been assigned to each of the landing zones in field 102. Target assignment routine 706 assigns mobile targets to operate on the field. FIG. 10 illustrates an example in which target T1 1048 has been assigned to be a target on field 102 and follow path 1052. Sensor data collection routine 708 collects and/or processes sensor data communicated from tee off booths and from gofers. Tee of detection routine 710 detects a tee off within a tee off booth based on examination and processing of received sensor data, e.g. images from a swing camera, or based on an indication received the tee off booth that a ball has been driven. In various embodiments, detection operations include time tagging and position tagging the detected tee off (e.g., booth number or tee off coordinates).

Ball/golfer association routine 712 associates a golfer with a set of balls, e.g. a set of balls based on RFIDs, or a set of balls based on ball cover color, pattern, and/or marking(s). Ball identification (ID) routine 714 identifies a ball, e.g. a ball about to be teed off, e.g. based on detected RFID value or a captured image, which is communicated from the tee off booth the station 600, and using stored ball ID information 754. Tee off time determination routine 716 determines a time of tee off, e.g., based on a received captured image or other sensor information from the tee off both or an indication from the tee off booth that a ball has been driven. Initial launch vector determination routine 718 determines a ball launch vector, e.g. a vector with an end point at the launch point where the ball leaves the club, with the determined initial speed and with the determined initial direction. Routine 718 includes a launch speed determination routine 720 which determines a ball launch speed based on reported radar camera data, swing camera images, or IR data received from the tee off booth. Launch direction determination routine 722 determines a direction of ball launch, e.g., with respect to a reference frame, based on reported captured images, e.g. from one or more swing cameras. Ball spin determination routine 724 determines a direction and rate of spin of the ball being driven based on evaluation of time tagged reported captured images of the ball just after it leaves the end of the club. Ball trajectory estimation routine 726 estimates a flight path for the driven ball based on the determined ball launch vector, determined wind speed, determined wind direction, and in some embodiment, captured images from cameras (432, 434) monitoring the air space above the field and/or from captured radar images/data from Doppler radar unit 430. Ball landing position estimation routine 728 estimates the landing coordinates of the driven ball, e.g. based on the estimated projected flight path, and/or estimates the coordinates on the field where the ball is expected to come to rest, e.g. based on the estimated speed and angle at which the ball hits the field and the current field conditions. Ball landing zone prediction routine 730 predicts which landing zone the driven ball is expected to land in based on the ball landing position estimation and the golf range map information 750. Tee off information/ball flight information 732 stores a set of information corresponding to a driven ball, e.g., ball ID info, golfer ID info, initial launch vector, predicted flight path information, predicted landing coordinates, e.g. in golfer records 794. Gofer identification routine 734 identifies a particular gofer which is to be sent to search for, determine the location of and retrieve the driven ball, e.g., based on the predicted landing zone an gofer availability. Gofer assignment routine assigns a gofer, e.g. the identified gofer, to search for, determine the location of and retrieve the driven ball. In various embodiments, gofer assignment routine 736 generates a message and/or ball report to be communicated (e.g., wirelessly) to the assigned gofer, said message and/or ball report including ball ID information, the projected ball trajectory, a predicted landing location and/or a predicted final resting location, and a time tag for the tee off drive time, and optionally golfer ID information. Score update routine 738 updates a golfer's scored based on a received ball report from a gofer. Location marking routine 740 commands a golfer or a teeing booth to mark a determined ball landing location or ball final resting location on the field, e.g. using a light beam, smoke, mist, etc. Award routine 742 determines that a golfer should be awarded and award, e.g., based on a score above a presented threshold, and sends a command to the teeing booth to present the award, e.g. on a display or via a speaker. Replacement assignment routine 744 selects an available gofer or moving target, e.g. from among available spare units in a parking garage, to replace a gofer or moving target which is expected to need a battery recharge or need to discharge collected balls, and sends a message to the selected replacement gofer or mobile target commanding the replacement vehicle to go to a designated location to take over operations from the vehicle in need of service.

Data/information 628 includes golf range map information 750, e.g., information identifying a plurality of landing areas within the golf range onto which golf balls are driven, golfer ID information 752, e.g., set of information, e.g., a name, player ID, club membership ID, etc., associated with each golfer, and ball ID information 754, e.g. information such as RFID values, different colors, different patterns, different markings, e.g., used to distinguish different balls or different sets of balls. Data/information 628 further includes received detected ball ID information 756, e.g., a detected RFID corresponding to a ball about to driven or a detected ball cover pattern corresponding to a ball about to be driven, received captured sensor information 758, e.g., received captured images or data from various sensors (ball examination camera, RFID tee off detector, swing cameras, IR sensors, Doppler radar, field cameras, wind speed sensor, wind direction sensor) monitoring within a tee off booth and/or monitoring the field or above the field, detected tee off information 760, e.g., a set a information corresponding to a detected tee off including a tee off time tag, tee off booth ID info, golfer ID info, etc., a determined ball launch vector 762 including, e.g., launch coordinates (position), a launch direction, and a launch speed, estimated ball flight path 764, estimated ball landing coordinates 766, estimated ball final resting coordinates 768, an estimated ball landing zone 760, and a generated ball launch report 782, e.g., including ball ID info, e.g. RFID info or other ball ID info, e.g. markings, golfer ID info, launch time tag info, estimated landing and/or final resting location, said ball launch report to be sent (e.g., via wireless communications) to an identified gofer, which is to search for detect, determine actual location, and retrieve the ball. Data/information 628 further includes an identified gofer 784, which is to search for, detect, determine the actual ball location, and retrieve a particular golf ball, which was detected to be driven, gofer assignment messages 786, e.g., a generated message to be sent to a golfer assigning the golfer to: i) search for and recover a particular driven ball, ii) operate, patrol and recover balls, within a given area, e.g., a particular specified landing zone, or iii) operate the gofer to follow a particular mobile target and recover balls directed at the target; iv) operate the gofer as a mobile target; or v) report to a landing zone as a replacement golfer to replace a gofer which will shortly need to be recharged or will shortly need to discharge its collected balls. Data/information 628 further includes a received ball report from a gofer 788 including, e.g. recovered ball ID information, ball landing coordinates, and ball final resting coordinates, scoring information 790, e.g. a score for a player (golfer) based on a driven ball or an updated score based on evaluation of results of current driven ball and one or more previously driven balls, score results with regard to award criteria, award determination information. Data/information 628 further includes a mobile target assignment message, e.g. a message commanding a mobile target to follow a particular path, a command to stop at a point along the path, a command to continue along the path, etc. Data/information 794 further includes golf records 794 for each of a plurality of golfers (players) which use the golf practice range, said golf records including golfer ID information and results information.

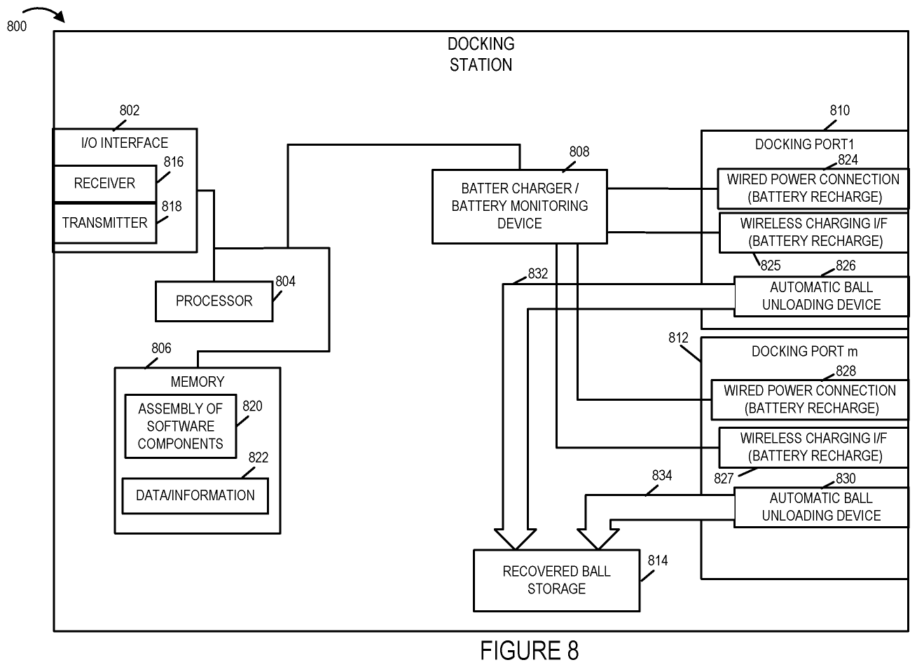

FIG. 8 is a drawing of an exemplary docking station 800 in accordance with an exemplary embodiment. Docking station 800 is, e.g., any of the docking station (146, 148, 150 of system 100 of FIG. 1. Docking station 800 includes an I/O interface 802 including a receiver 816 and a transmitter 818, a processor 804, e.g., a CPU, memory 806, and a battery charger/battery monitoring device 808 which are coupled together via a bus 811 over which the various elements may interchange data and information. Memory 806 includes an assembly of software components 820 and data/information 822.

Docking station 800 further includes one or more docking ports (docking porting 1 810, . . . , docking port m 812), and recovered ball storage 814, e.g. a container or receptacle for storing golf balls discharged by the gofers. Docking port 1 810 includes a wired power connection 824 for battery recharging and a wireless charging interface (I/F) 825 for battery recharging. Wired power connection 824 and the wireless charging I/F 825 are coupled to battery charger/battery monitoring device 808. The battery charger/battery monitoring device supplies energy, via connection 824 or wireless interface 825 to a gofer or mobile target, which is docked at docking port 1 810, to recharge the battery within the gofer or mobile target. Docking port 1 810 further includes an automatic ball unloading device 826 which unloads golf balls from a gofer which is docked at docking port 1 810 and directs the balls, e.g. via chute 832 to recovered ball storage area 814.

Docking port m 812 includes a wired power connection 828 for battery recharging and a wireless charging interface (I/F) 827 for battery recharging. Wired power connection 828 and the wireless charging I/F 827 are coupled to battery charger/battery monitoring device 808. The batter charger/battery monitoring device supplies energy, via connection 828 or wireless interface 827 to a gofer or mobile target, which is docked at docking port m 812, to recharge the battery within the gofer or mobile target. Docking port m 812 further includes an automatic ball unloading device 830 which unloads golf balls from a gofer which is docked at docking port m 812 and directs the balls, e.g. via chute 834 to recovered ball storage area 814.

I/O interface 802 couples the docking station 800, e.g., via a wired or fiber optic communications link to other devices, e.g. a command, control and communications station, e.g. command communications and control station 108 of FIG. 1. Exemplary messages sent, via transmitter 818, from docking station to a command, control and communications station include, e.g., docking station status information, e.g. operability of each of the charging stations, status of recovered balls, operability of each the automatic ball retrieval devices, status of each slot at the docking station (currently in use or vacant), gofer and mobile target information, e.g. information identifying gofers and targets currently at the station, battery status, estimated charging completion time, etc, and information to be communicated to a gofer or target to direct the gofer or target to a particular available port at the station, e.g. in response to a received request from the gofer or target, which was relayed through the wireless interface of the command, control and communications station. Exemplary messages received via receiver 816 of docking station from a command, control and communications station include, e.g., request for status update, a request for an available port for charging and a request for an available port of ball unloading.

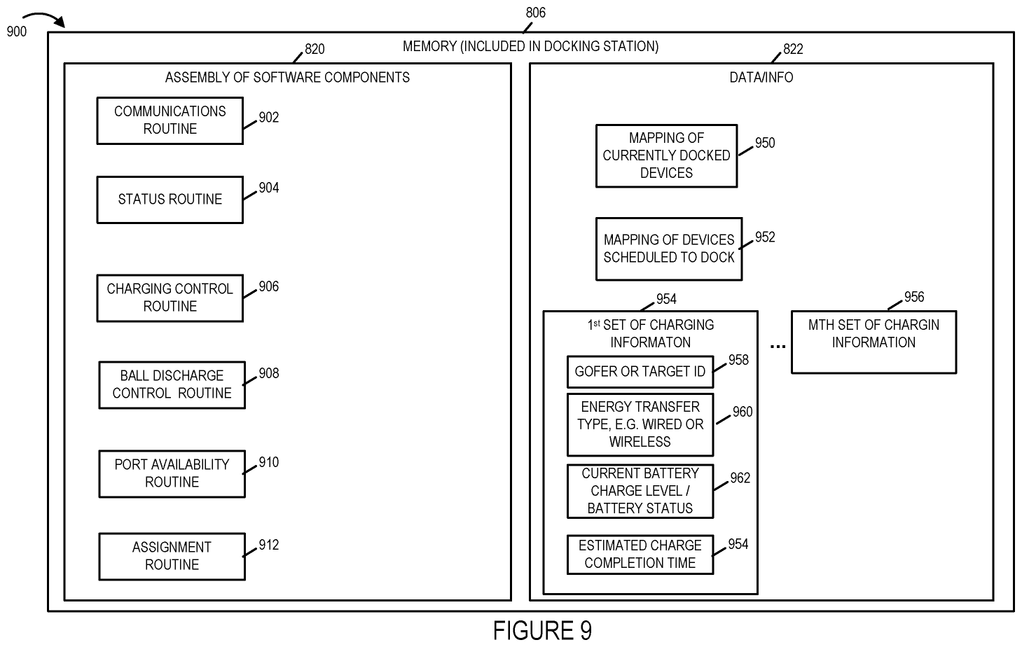

FIG. 9 is a drawing 900 illustrating an exemplary assembly of software components 820 and exemplary data/information 822 included in the memory 806 of an exemplary docking station 800 in accordance with an exemplary embodiment. Assembly of software components 820 includes a communications routine 902, a status routine 904, a charging control routine 906, a ball discharge control routine 908, a port availability routine 910 and an assignment routine 912. Communications routine 902 is configured to control receiver 816 to receive messages, e.g. from a controller, e.g. control station 108, and recover the communicated information, e.g., a request for status or a request to dock a gofer or target for battery recharge or ball unloading. Communications routine 902 is further configured to control transmitter 818 to send messages, e.g. to a controller, e.g. control station 108, communicating information, e.g., a response to request for docking including port information, a status report, etc. Status report 904 generates status reports to be communicated to a controller, e.g., a status report on the status of the charging equipment and the ball recovery equipment, a status report on charging a particular gofer or mobile target, a status report on unloading ball from a particular gofer, etc. Charging control routine 906 controls the operation of battery charger/battery monitoring device 802, wired power connections (824, 828) and wireless charging interfaces (825, 827), to perform battery monitoring and battery charging operations of batteries of docked devices. Ball discharge control routine 908 control the operation of automatic ball unloading devices (826, 830) to unload balls from docked gofers and direct the recovered ball into the recovered ball storage 814 and count the number of recovered balls.

Data/information 822 includes a mapping of currently docked device 950, a mapping of devices scheduled to dock 952, and a set of charging device information (first set of charging information 954, . . . . , m th. set of charging information 956) corresponding to each device which is currently being charged at docking station 800. Mapping of currently docked devices 950 includes information identifying for each device (gofer or target), which is currently docked at docking station 800, device ID information, information identifying which docking port is being used, and information identifying the reason for docking, e.g. battery recharge or ball unloading. Mapping of devices scheduled to dock 952 includes information identifying for each device (gofer or target), which is schedule to dock at docking station 800, device ID information, information identifying which docking port is to be used, information identifying the reason for docking, e.g. battery recharge or ball unloading, and information identifying the expected arrival time for docking. First set of charging information 954 includes gofer or mobile target ID information 958, energy transfer type information 960, e.g. indicating wired energy transfer or wireless energy transfer, current battery charger level/battery status 962, and estimated charge completion time 964.

FIG. 10 is a drawing 1000 of the exemplary golf practice facility 100 of FIG. 1 which further illustrates exemplary gofers and exemplary mobile targets in accordance with an exemplary embodiment. Gofer 1 (G1) 1002, has been assigned to patrol and collect golf balls in landing zone A1 114 and is currently located within landing zone A1 114. Gofer 2 (G2) 1004, has been assigned to patrol and collect golf balls in landing zone B3 126 and is currently located within landing zone B3 126. Gofer 3 (G3) 1006 is currently located at repair facility 110. Gofer 4 (G4) 1008, has been assigned to patrol and collect golf balls in landing zone C1 130 and is currently located within landing zone C1 130. Gofer 5 (G5) 1010 is currently docked at a first port of docking station 2 148, e.g., for battery recharging and/or ball discharge. Gofer 6 (G6) 1012, has been assigned to patrol and collect golf balls in landing zone A2 116 and is currently located within landing zone A2 116. Gofer 7 (G7) 1014, has been assigned to patrol and collect golf balls in landing zone C2 132 and is currently located within landing zone C2 132. Gofer 8 (G8) 1016 is currently docked at a second port of docking station 2 148, e.g., for battery recharging and/or ball discharge. Gofer 9 (G9) 1018, has been assigned to patrol and collect golf balls in landing zone A3 118 and is currently located within landing zone A3 118. Gofer 10 (G10) 1020, has been assigned to patrol and collect golf balls in landing zone B2 124 and is currently located within landing zone B2 124. Gofer 11 (G11) 1022 is currently located within parking garage 112 and is a spare unit ready to be reassigned. Gofer 12 (G12) 1024, has been assigned to patrol and collect golf balls in landing zone A4 120 and is currently located within landing zone A4 120. Gofer 13 (G13) 1026 is currently located at repair facility 110. Gofer 14 (G14) 1028 is currently located within parking garage 112 and is a spare unit ready to be reassigned. Gofer 15 (G15) 1030, has been assigned to patrol and collect golf balls in landing zone B1 122 and is currently located within landing zone B1 122. Gofer 16 (G16) 1032 is currently located within parking garage 112 and is a spare unit ready to be reassigned. Gofer 17 (G17) 1034 is currently docked at a port of docking station 3 150, e.g., for battery recharging and/or ball discharge. Gofer 18 (G18) is in transit travelling along path 1056 toward docking station 1 146. Gofer 19 (G19) 1038 is currently located within parking garage 112 and is a spare unit ready to be reassigned. Gofer 20 (G20) 1040, has been assigned to patrol and collect golf balls in landing zone C3 134 and is currently located within landing zone C3 134. Gofer 21 (G21) 1042, has been assigned to patrol and collect golf balls in landing zone B4 128 and is currently located within landing zone B4 128. Gofer 22 (G22) 1044, has been assigned to patrol and collect golf balls in landing zone C4 136 and is currently located within landing zone C4 136. Gofer 23 (G23) has been assigned to follow mobile target 1 (T1) 1048 (as indicated by arrow 1054) and collect ball directed at mobile target T1 1048.

Mobile target 1 (T1) 1048 has been directed to move along path 1052, e.g., and stop and predetermined points along the path. Mobile target 2 (T2) 1050 is currently located within parking garage 112 and is a spare unit ready to be reassigned.

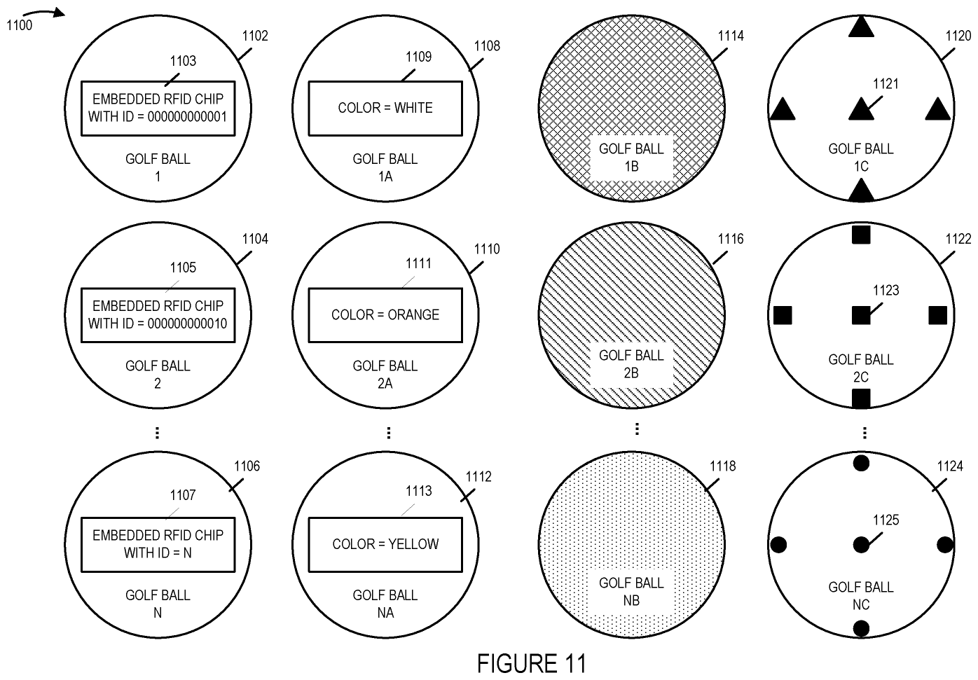

FIG. 11 is a drawing 1100 of exemplary identifiable golf balls in accordance with various exemplary embodiments. First exemplary set of golf balls (1102, 1104, . . . , 1106) are identifiable based on an RFID. Each golf ball (golf ball 1 1102, golf ball 2 1104, . . . , golf ball N 1106) includes an RFID chip (1103, 1105, . . . , 1107), respectively. In this example, RFID chip 1103 communicates ID value=000000000001; RFID chip 1105 communicates ID value=000000000002; and RFID chip 1107 communicates RFID value=N. In some embodiments, a particular subset of golf balls, with a corresponding subset of RFID values is assigned to, associated with and mapped to a particular golfer on the range. For example, a first subset of balls, with a corresponding first subset of RFID values; is mapped to a first golfer; and a second subset of balls, with a corresponding second subset of RFID values is mapped to a second golfer; etc.

Second set of golf balls (1108,1110, . . . , 1112) are identifiable based on color. For example golf balls of type 1A 1108, which are white (1109) in color are assigned to and associated with a first golfer; golf balls of type 2A 1110, which are orange (1111) in color are assigned to and associated with a second golfer; and golf balls of type NA 1112, which are yellow (1112) in color are assigned to and associated with an Nth golfer.

Third set of golf balls (1114,1116, . . . , 1118) are identifiable based on a pattern on the surface of the golf ball. For example golf balls of type 1B 1114, which have a crosshatch pattern on the cover are assigned to and associated with a first golfer; golf balls of type 2B 1116, which have a slanted line pattern on the cover are assigned to and associated with a second golfer; and golf balls of type NB 1118, which have a dot pattern with a first spacing between the dots are assigned to and associated with an Nth golfer.

Fourth set of golf balls (1120,1122, . . . , 1122) are identifiable based on a symbol on the surface of the golf ball. For example golf balls of type 1C 1120, which have a triangle symbols on the ball cover are assigned to and associated with a first golfer; golf balls of type 2C 1122, which have a square symbols on the cover are assigned to and associated with a second golfer; and golf balls of type NC 1124, which have circle symbols on the ball cover are assigned to and associated with an Nth golfer.

In some embodiments, the symbols placed on the ball covers, which are used to distinguish between different golfers are QR symbols. In some embodiments, the bar codes or numbers are placed on the ball covers, which are used to distinguish between different golfers. In some embodiments, combinations of colors, patterns, and/or symbols are used to distinguish between different golfers. In some embodiments, ball identification information, e.g., ball markings, is viewable when the ball is subjected to UV light.

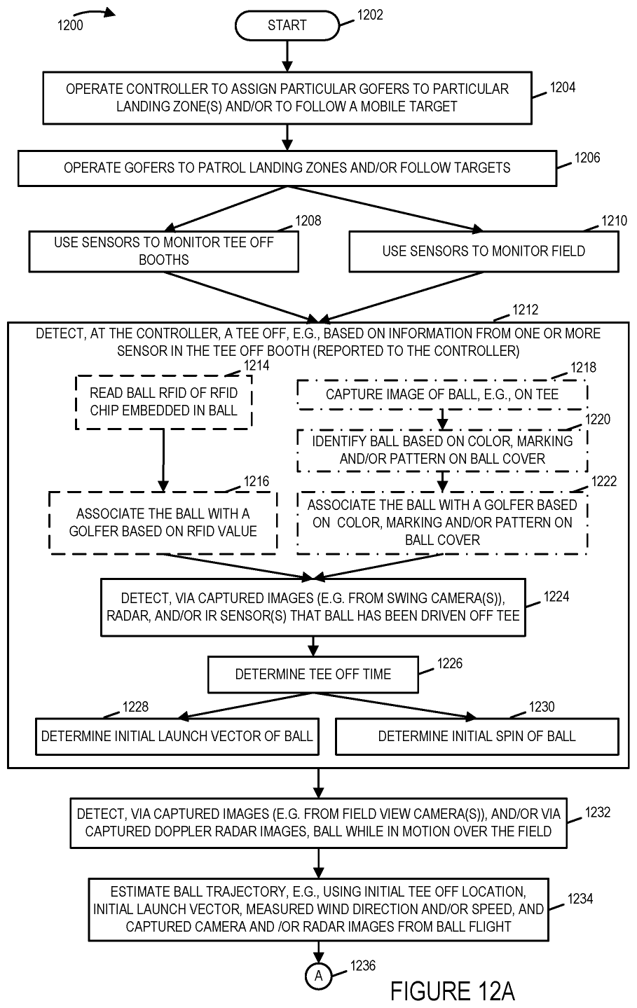

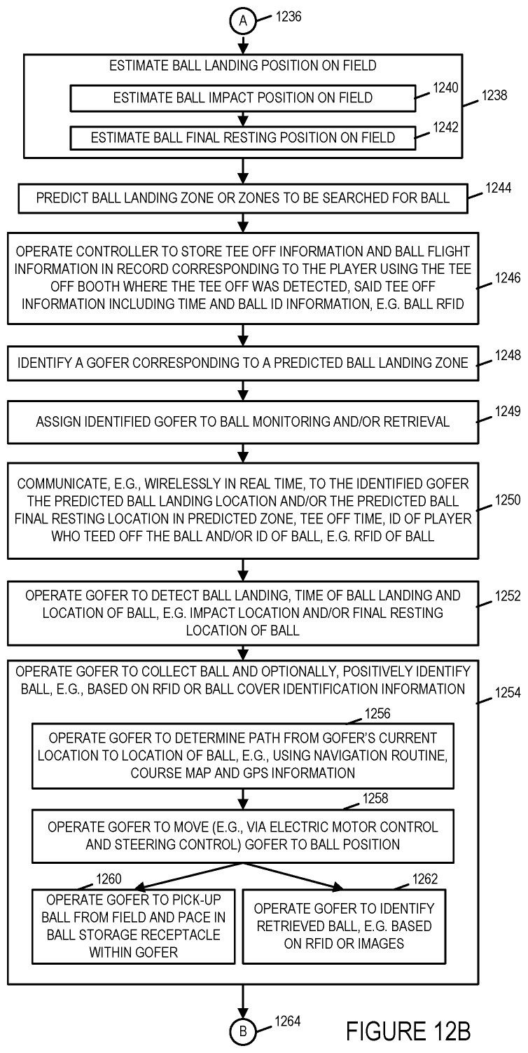

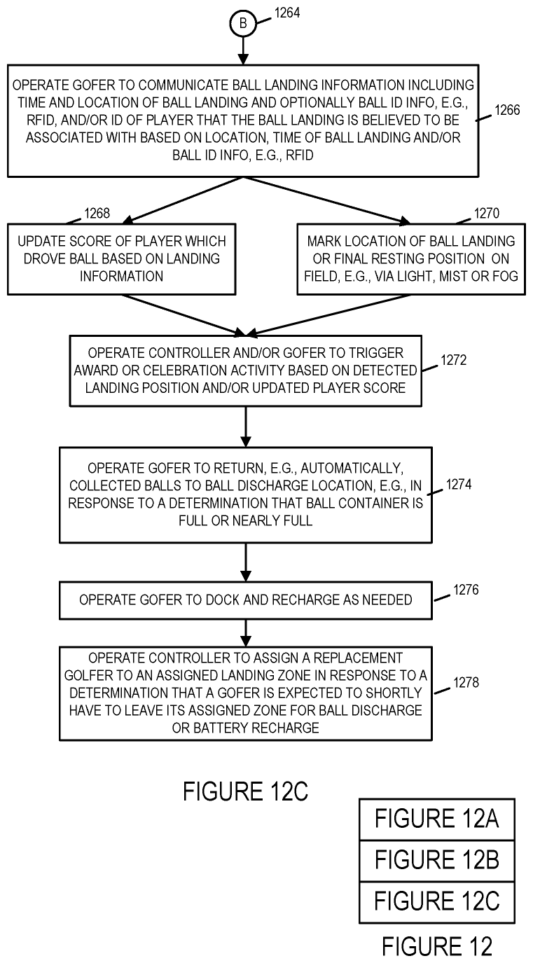

FIG. 12, comprising the combination of FIG. 12A, FIG. 12B and FIG. 12C, is a flowchart 1200 of an exemplary method of operating a system, e.g., system 100, which tracks and recovers golf balls, e.g., in a practice range, in accordance with an exemplary embodiment. Operation starts in step 1202 in which the system, e.g., system 100 is powered on and initialized. Operation proceeds from step 1202 to step 1204.

In step 1204, a controller, e.g., central processing, control and communications station 108, is operated to assign particular gofers to particular landing zone(s) (golf ball landing zones) and/or to follow a mobile target. FIG. 10 illustrates exemplary gofers which have been assigned to different landing zones and a gofer which has been assigned to follow a mobile target. Operation proceeds from step 1204 to step 1206. In step 1206 the gofers are operated to patrol landing zones and/or the follow targets. Operation proceeds from step 1206 to step 1208 and step 1210.

In step 1208 sensors, e.g., ball examination camera 426, RFID sensor 428, radar camera 416, swing cameras 418, 420, IR sensors 422, 424, are used to monitor tee off booths, e.g. tee off booths (128,140,142, 144). In step 1210 sensors, e.g., Doppler radar unit 430 and field cameras 432, 434, are used to monitor the field 102. Operation proceeds from step 1208 and step 1210 to step 1212.

In step 1212 the controller detects, a tee off, e.g. based on information from one or more sensors in a tee off booth reported to the controller. In some embodiments, each golf ball includes an embedded RFID chip and steps 1214 and 1216 are performed. In other embodiments, the gold balls do not include RFID chips and steps 1218, 1220 an 1222 are performed.

In step 1214 a sensor in the tee off booth, under the direction of the controller, reads the ball RFID of the chip embedded in the golf ball, e.g., a golf ball on a tee about to be driven. Operation proceeds from step 1214 to step 1216. In step 1216 ball is associated with a golfer based on the RFID value. In some embodiments the detected RFID value is communicated to the controller which makes the association. In other embodiments, the association between the ball and a golfer is performed within the tee off booth by a processor, and the determined association is communicated to the controller.

In step 1218 a camera, e.g. ball examination camera 426, under the control of the controller, captures an image of a ball, e.g. golf ball 405, on a tee, e.g., tee 403. Operation proceeds from step 1218 to step 1220. In step 1220 the ball is identified based on color, markings and/or a pattern on the ball cover. The identification is performed in the teeing booth by a processor and reported to the controller or the captured image is sent to the controller which performs the identification. Then, in step 1222, the ball is associated, e.g., by the controller, with a golfer based on the identified color, marking and/or pattern on the ball cover.

Operation proceeds from step 1216 or step 1222 to step 1224. In step 1124 the controller detects, via captured images, e.g. from the swing cameras, via radar data, and/or via IR sensor data that the ball has been driven off the tee. Operation proceeds from step 1224 to step 1226 in which the tee off time is determined, e.g., time of golf club/golf ball impact is detected in the tee off booth, time tagged and reported to the controller or the controller determines the tee off time from examining time tagged images sent to the controller. Operation proceeds from step 1226 to step 1228 and step 1230.

In step 1228 an initial launch vector of the ball is determined, e.g., by the processor, e.g. processor 404 of the tee off station based on sensor data in the tee off station, and then reported to the controller, e.g., controller 108, or is determined by the controller based on sensor data, e.g., captured images from the swing camera and radar camera and/or data from the IR sensors, communicated to the controller. In step 1230 the initial spin of the ball is also determined, e.g., by the processor in the tee off station and reported to the controller or by the controller directly based on sensor data communicated from the tee off station to the controller.

Operation proceeds from step 1212 to step 1232. In step 1232 the ball, while in motion over the field is detected, e.g. via captured images, e.g., from field cameras 432, 434, and/or via captured Doppler radar images from Doppler radar unit 430. Operation proceed from step 1232 to step 1234.

In step 1234 the ball trajectory is estimated, e.g. by the controller, e.g., using the initial tee off location, the determined initial launch vector, measured wind direction and/or measured wind speed, captured camera images of the ball flight and/or captured radar images of the ball flight. Operation proceeds from step 1234, via connecting node A 1236, to step 1238.

In step 1238 the ball landing position on the field is estimated, e.g. by the controller. Step 1238 includes step 1240 in which the ball impact position on the field is estimated, and step 1242 in which the ball final resting position on the field is estimated. Operation proceeds from step 1238 to step 1244, in which the controller predicts the ball landing zone or zones, which are to be searched for the driven ball. Operation proceeds from step 1244 to step 1246.

In step 1246 the controller stores tee off information and ball flight information in a record corresponding to the player using the tee off booth where the tee off was detected, said tee off information including time and ball ID information, e.g. ball RFID. Operation proceeds from step 1246 to step 1248.

In step 1248 the controller identifies a gofer corresponding to the predicted ball landing zone. Operation proceeds from step 1248 to step 1249 in which the controller assigns the identified gofer to ball monitoring and retrieval. Operation proceeds from step 1249 to step 1250.

In step 1250 the controller communicates, e.g. wirelessly in real time, to the identified gofer the predicted ball landing location and/or the predicated ball final resting location in the predicted zone, tee off time, ID of player whO teed off the ball and/or ID of the ball, e.g., RFID of ball. Operation proceeds from step 1250 to step 1252.

In step 1252 the assigned gofer is operated to detect the ball landing, time of landing and location of ball, e.g., impact location and/or final resting location of the ball. In some embodiments, cameras included in the gofer are used to capture images of the ball during flight, during landing and/or after landing. In some embodiments, the position of the gofer is determined by the gofer, e.g. based on GPS information, DGPS information, and/or IMU information. In some such embodiments, the location of the ball is determined by the gofer based on the known location of the gofer and a determined range and direction to the ball from the location of the gofer, e.g. based on information from range finding sensors included in the gofer and/or based on processed captured images including the ball. Operation proceeds from step 1252 to step 1254.

In step 1254 the gofer is operated to collect the ball and optionally, positively identify the ball, e.g., based on RFID of the ball or ball cover identification information. Step 1254 includes steps 1256, 1258, 1260 and 1262. In step 156 the gofer determines a path from the gofer's current location to the location of the ball, e.g., using its navigation routine, course map and GPS information. Operation proceeds from step 1256 to step 1258. In step 1258 the gofer moves, e.g. via electric motor control and steering control, the gofer to the ball position, e.g., in accordance with the determined navigation path. Operation proceeds from step 1258 to step 1260 and step 1262. In step 1260 the gofer is operated to pick-up the ball from the field and then place the recovered ball in the ball storage receptacle within the gofer. In step 1262 the gofer is operated to identify the retrieved ball, e.g., based on RFID or images of the ball. Operation proceeds from step 1254, via connecting node B 1264, to step 1266.

In step 1266 the gofer is operated to communicate ball landing information, e.g., a ball landing report, said ball landing information including time and location of the ball landing, and optionally ball ID information, e.g., RFID, and/or ID of the player the ball landing is believed to be associated with based on location, time of ball landing and/or ball landing information, e.g. RFID. Operation proceeds from step 1266 to step 1268 and step 1270.

In step 1268 the controller updates the score of the player who drove the ball based on the landing information. In step 1270 the location of the ball landing or final ball resting position on the field is marked, e.g., via light, mist or fog, e.g. by the gofer under the direction of the controller, e.g. in response to a received command from the controller. Operation proceeds from steps 1268 and 1270 to step 1272.

In step 1272 the controller and/or gofer are operated to trigger an award or celebration activity based on the detected landing position and/or the updated player score. Operation proceeds from step 1272 to step 1274.

In step 1274 the gofer is operated to return, e.g., automatically, collected balls to a ball discharge location, e.g., in response to a determination that the ball container in the gofer is full or nearly full. Operation proceeds from step 1274 to step 1276.

In step 1276 the gofer is operated to dock, e.g., at an available docking station, and recharge as needed. Operation proceeds from step 1276 to step 1278.

In step 1278 the controller assigns a replacement gofer to an assigned landing zone in response to a determination that a gofer is expected to shortly have to leave its assigned zone for ball discharge or battery recharge. For example, in various embodiments, the gofer monitors its battery status, and when low, sends a request to the controller for a battery recharge. Then, the controller, which is also managing the docking stations, finds an available slot for the gofer in need of a recharge. The controller assigns a replacement gofer (e.g., from the parking garage) to cover for the gofer which needs a recharge and sends the replacement gofer to the field. When the replacement gofer arrives in the assigned landing zone, the controller notifies the gofer in need of a recharge that it may now proceed to the identified available charging slot.

Numbered List of Exemplary System Embodiments

System Embodiment 1 A system (100) comprising: a sensor (416, 418, 420, 422, 424, 430, 432, or 434) located in a teeing booth (138, 140, 142, 144 or 400); a control system (108 or 600) coupled to said sensor (416, 418, 420, 422, 424, 430, 432, or 434), the control system (108 or 600) including a control system processor (606) configured to predict a ball landing location based on sensor information provided by said sensor (416, 418, 420, 422, 424, 430, 432, or 434); and a first mobile golf ball collecting vehicle (e.g., gofer) (1002, 1004, 1006, 1008, 1010, 1012, 1014, 1016, 1018, 1020, 1022, 1024, 1026, 1028, 1030, 1032, 1034, 1036, 1038, 1040, 1042, 1044, 1046, or 200) including a first sensor (216, 218, or 220) and a wireless transmitter (210).

System Embodiment 2 The system (100) of System Embodiment 1, wherein said first sensor (216, 218, or 220) is a camera (216, 218, 220) for taking an image of a golf ball (281, 282, 284, 286, 288, 290, 1102, 1104, 1106, 1108, 1110, 1112, 1114, 1116, 1118, 1120, 1122, or 1124)) at a golf ball landing area.

System Embodiment 3 The system (100) of System Embodiment 2, wherein said first mobile golf ball collecting vehicle (200) further includes a range finding device (226 or 228) for determining a distance to said golf ball at the golf ball landing area.

System Embodiment 4 The system (100) of System Embodiment 3, wherein said first mobile golf ball collecting vehicle (200) further includes a processor (202), said processor (202) being configured to determine the position of the golf ball at the golf ball landing area based on distance information from said range finding device and a known position of the golf ball collecting vehicle.

System Embodiment 5 The system (100) of System Embodiment 4, wherein the processor (202) of the first mobile golf ball collecting vehicle (2002) is configured to control the golf ball collecting vehicle to wirelessly report the determined location of said golf ball via wireless signals transmitted by the wireless transmitter (210) in said golf ball collecting vehicle (200).

System Embodiment 6 The system (100) of System Embodiment 5, wherein said control system (108 or 600) is further configured to perform one, more or all of: updating a player score (e.g., displayed on scoreboard display 410 in teeing booth 400) based on the reported location of the golf ball, triggering an audio announcement (e.g., via speaker 408 in teeing booth 400) based on the reported location of the golf ball, projecting an image on a screen (e.g., image on video display 412 in teeing booth 400) or field (e.g., projected image 257 on field generated via light projector 256 in gofer 200) or projecting or releasing smoke or mist on the field (e.g., smoke or mist 255 generated by smoke/mist generator 254 of gofer 200 is released on the field), said image being determined based on the reported location of the golf ball, or triggering an action or display on a portion of a golf course (field) based on the reported location of the golf ball.

System Embodiment 7 The system (100) of System Embodiment 6, wherein said system (100) includes a plurality of mobile golf ball collecting vehicles (1002, 1004, 1006, 1008, 1010, 1012, 1014, 1016, 1018, 1020, 1022, 1024, 1026, 1028, 1030, 1032, 1034, 1036, 1038, 1040, 1042, 1044, and 1046); and wherein said control system processor (606) is configured to: identify a mobile golf ball collecting vehicle (e.g., vehicle G1 1002) in the predicted ball landing area (e.g., landing zone A1 114); and signal to the identified mobile golf ball collecting vehicle (e.g., vehicle G1 1002) to monitor for said golf ball (1102, 1104, 1106, 1108, 1110, 1112, 1114, 1116, 1118, 1120, 1122, or 1124).

System Embodiment 8 The system (100) of System Embodiment 7, wherein said golf ball (1108, 1110, 1112, 1114, 1116, 1118, 1120, 1122, or 1124) does not include an RFID chip (e.g. RFID chip 1103 in golf ball 1102).

System Embodiment 9 The system (100) of System Embodiment 8, wherein the control system processor (606) determines a player to which a golf ball corresponds based on an image of the golf ball provided by the mobile golf ball collecting vehicle, said processor (606) using a color or pattern on the golf ball to identify the player to which the golf ball corresponds.

System Embodiment 10 The system of System Embodiment 9, wherein said first mobile golf ball collecting vehicle (e.g., gofer 1002) is a semi-autonomous electric powered vehicle.

System Embodiment 11 The system (100) of System Embodiment 10, further including a mobile golf ball collecting vehicle dock (146, 148, or 150 or 800) including a wireless charger or a wired charging port (808, 824/825); and wherein said first mobile golf ball collecting vehicle (e.g., gofer G1 1002) is a semi-autonomous electric powered vehicle; and wherein the processor (202) in the first mobile golf ball collecting vehicle (e.g., gofer G1 1002) controls the vehicle to return to said mobile golf ball collecting vehicle dock (146, 148, or 150 or 800) for recharging and/or automatic golf ball unloading.

System Embodiment 12 The system (100) of System Embodiment 11, wherein said control system processor (606) is configured to control said control system (600) to deploy another mobile golf ball collecting vehicle (G11 1022, G14 1028, G16 1032 or G19 1038) to an area (e.g., landing zone area A1 114) previously covered by said first mobile golf ball collecting vehicle (e.g., gofer G1 1002) when the first mobile golf ball collecting vehicle (e.g., gofer G1 1002) is to leave the area (e.g., landing zone area A 114) for charging, ball unloading and/or service.

System Embodiment 13 The system (100) of System Embodiment 1 further including a mobile target (T1 1048, T2 1050 or 200 including target 274).

System Embodiment 14 The system (100) of System Embodiment 13 wherein the mobile target (1048, 1050 or 200 including target 274) and/or mobile golf ball collecting vehicle (1002, 1004, 1006, 1008, 1010, 1012, 1014, 1016, 1018, 1020, 1022, 1024, 1026, 1028, 1030, 1032, 1034, 1036, 1038, 1040, 1042, 1044, 1046, and 200) are battery powered robotic devices.

Numbered List of Exemplary Method Embodiments

Method Embodiment 1 A method, the method comprising: operating a mobile cart (e.g., ball collection cart sometimes referred to as a gofer) to communicate (1266) ball landing information to a control device (e.g., controller), said ball landing information providing information relating to a ball which was driven by a player; and operating the control device to update (1268) a score of the player based on the ball landing information.

Method Embodiment 2 The method of Method Embodiment 1, wherein said ball landing information indicates a resting location of the ball or a point of impact of the ball.

Method Embodiment 3 The method of Method Embodiment 1, further comprising: operating the control device to trigger an action (1272) based on the updated score, said action including one, more or all of: i) updating a displayed score corresponding to the player, ii) automated presentation of an award (e.g., a visual award displayed to the player and/or guests and/or a physical award such as presentation of a trophy to the player e.g., automatically); iii) a celebration activity such as a light, smoke or water show.

Method Embodiment 3A The method of Method Embodiment 3 wherein the triggered action is implemented by a device in the system, e.g., a laser light projector, a smoke generation device, a score display board, and/or an award presentation device such as a vending machine which automatically provides an award to a user achieving a particular score or achievement.

Method Embodiment 4 The method of Method Embodiment 2, wherein the ball landing information includes a time at which the ball landed or came to rest.

Method Embodiment 5 The method of Method Embodiment 4, further comprising: operating the mobile cart to retrieve (1260, e.g., pickup the ball from the field) the ball.

Method Embodiment 6 The method of Method Embodiment 5, further comprising: operating the mobile cart (e.g., a processor in the mobile cart) to identify (1262) the retrieved ball based on an RFID signal or an image of the retrieved ball (e.g., based on a number or bar code on the ball which is scanned by a camera when the ball is retrieved).

Method Embodiment 6A The method of Method Embodiment 6, wherein said ball landing information includes ball identification information (RFID value or ID obtained from optical image).

Method Embodiment 7 The method of Method Embodiment 5, further comprising: operating the mobile cart to mark (1270) (e.g., with paint, dye or other temporary marker such as bio-degradable paper or laser target indicator) the ball landing location or final resting location of the ball.

Method Embodiment 8 The method of Method Embodiment 5, further comprising: operating the mobile cart to automatically return (1272) collected balls to a ball discharge location.

Method Embodiment 9 The method of Method Embodiment 8, further comprising: operating the mobile cart to automatically dock (1276) with a docking station and recharge batteries in the mobile cart.

Method Embodiment 10 The method of Method Embodiment 9, further comprising: operating the control device to assign (1278) a replacement mobile cart to a landing zone for a period of time during which said mobile cart is recharging batteries.

Method Embodiment 11 The method of Method Embodiment 1, further comprising: using sensors to monitor (1208) one or both of i) tee off booths or ii) a field where balls can be driven; and operating the control device to estimate (1234) a ball trajectory based on one or more sensor measurements (e.g. measurement of initial launch vector ((e.g., direction), ball speed, wind speed and/or optical measurements of ball path).

Method Embodiment 12 The method of Method Embodiment 11, further comprising: operating the control device to estimate (1238) a ball landing position on the field.

Method Embodiment 13 The method of Method Embodiment 12, operating the control device to identify (1248) a mobile cart corresponding to the predicted landing zone, said identified mobile cart being said mobile cart.

Method Embodiment 14 The method of Method Embodiment 13, further comprising: operating the control device to assign (1249) the identified mobile cart monitor landing of the ball and/or retrieval of the ball.

Method Embodiment 15 The method of Method Embodiment 13, further comprising: operating the control device to communicate (1250) wirelessly in real time to the mobile cart predicted ball landing information.

Method Embodiment 16 The method of Method Embodiment 1, further comprising: operating the mobile cart (1206) to follow a target vehicle which includes or has a target mounted on it.

Numerous variations on the above described methods and apparatus are possible. In various embodiments ball impact and/or landing location are observed by the gofer unit and the impact or landing location determined using a targeting device, range finder, captured image, and/or optical or sensor measurement to accurately determine the ball impact and/or landing location as well as the time of impact and/or landing. In some embodiments this information is wirelessly communicated back to a controller before the ball is collected. Sensor determined impact or landing location information can be and sometimes is updated or supplemented based on information about the precise location a ball is collected. Alternatively, in less time critical implementations a ball can be, and sometimes is, collected, an RFID or optical marker examined and the precise collection point reported as the ball landing location.

Numerous additional variations on the methods and apparatus of the present invention described above will be apparent to those skilled in the art in view of the above description of the invention. Such variations are to be considered within the scope of the invention. The methods and apparatus of the present invention may be, and in various embodiments are, implemented using a variety of wireless communications technologies such as CDMA, orthogonal frequency division multiplexing (OFDM), WiFi, and/or various other types of communications techniques which may be used to provide wireless communications links between mobile ball retrieval vehicles and the control device, e.g., controller. Furthermore the gofers can take a wide variety of forms with some being tracked vehicles and others being wheeled vehicles.

Some aspects and/or features are directed a non-transitory computer readable medium embodying a set of software instructions, e.g., computer executable instructions, for controlling a computer or other device, e.g., a controller or mobile ball collection or target vehicle to operated in accordance with the above discussed methods.

The techniques of various embodiments may be implemented using software, hardware and/or a combination of software and hardware. Various embodiments are directed to a control apparatus, e.g., controller which can be implemented using a microprocessor including a CPU, memory and one or more stored instructions for controlling a device or apparatus to implement one or more of the above described steps. Various embodiments are also directed to methods, e.g., a method of determining ball landing and/or resting location, collecting balls and/or performing one or more of the other operations described in the present application. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above various features of the present invention are implemented using modules. Such modules may, and in some embodiments are, implemented as software modules. In other embodiments the modules are implemented in hardware. In still other embodiments the modules are implemented using a combination of software and hardware. In some embodiments the modules are implemented as individual circuits with each module being implemented as a circuit for performing the function to which the module corresponds. A wide variety of embodiments are contemplated including some embodiments where different modules are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a mobile vehicle which implements one or more of the steps of the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed is:

1. A system comprising:
a sensor located in a teeing booth;
a control system coupled to said sensor, the control system including a control system processor configured to predict a ball landing location based on sensor information provided by said sensor; and
a first mobile golf ball collecting vehicle including a first sensor and a wireless transmitter.

2. The system of claim 1, wherein said first sensor is a camera for taking an image of a golf ball at a golf ball landing area.

3. The system of claim 2, wherein said first mobile golf ball collecting vehicle further includes a range finding device for determining a distance to said golf ball at the golf ball landing area.

4. The system of claim 3, wherein said first mobile golf ball collecting vehicle further includes a processor, said processor being configured to determine the position of the golf ball at the golf ball landing area based on distance information from said range finding device and a known position of the golf ball collecting vehicle.

5. The system of claim 4, wherein the processor of the first mobile golf ball collecting vehicle is configured to control the golf ball collecting vehicle to wirelessly report the determined location of said golf ball via wireless signals transmitted by the wireless transmitter in said golf ball collecting vehicle.

6. The system of claim 5, wherein said control system is further configured to perform one, more or all of:
updating a player score based on the reported location of the golf ball, triggering an audio announcement based on the reported location of the golf ball, projecting an image on a screen or field or projecting or releasing smoke or mist on the field, said image being determined based on the reported location of the golf ball, or triggering an action or display on a portion of a golf course based on the reported location of the golf ball.

7. The system of claim 6,
wherein said system includes a plurality of mobile golf ball collecting vehicles; and
wherein said control system processor is configured to:
identify a mobile golf ball collecting vehicle in the predicted ball landing area; and
signal to the identified mobile golf ball collecting vehicle to monitor for said golf ball.

8. The system of claim 7, wherein said golf ball does not include an RFID chip.

9. The system of claim 8, wherein the control system processor determines a player to which a golf ball corresponds based on an image of the golf ball provided by the mobile golf ball collecting vehicle, said processor using a color or pattern on the golf ball to identify the player to which the golf ball corresponds.

10. The system of claim 1 further including a mobile target.

11. The system of claim 10 wherein the mobile target and/or mobile golf ball collecting vehicle are battery powered robotic devices.

12. A method, the method comprising:
operating a mobile cart to communicate ball landing information to a control device, said ball landing information providing information relating to a ball which was driven by a player; and
operating the control device to update a score of the player based on the ball landing information.

13. The method of claim 21, wherein said ball landing information indicates a resting location of the ball or a point of impact of the ball.

14. The method of claim 12, further comprising:
operating the control device to trigger an action based on the updated score, said action including one of: i) updating a displayed score corresponding to the player, ii) triggering presentation of an award; iii) trigger a celebration activity such as a light, smoke or water show.

15. The method of claim 13, wherein the ball landing information includes a time at which the ball landed or came to rest.

16. The method of claim 15, further comprising:
operating the mobile cart to retrieve the ball.

17. The method of claim 16, further comprising:
operating the mobile cart to identify the retrieved ball based on an RFID signal or an image of the retrieved ball.

18. The method of claim 16, further comprising:
operating the mobile cart to automatically return collected balls to a ball discharge location.

19. The method of claim 12, further comprising:
using sensors to monitor one or both of i) tee off booths or ii) a field where balls can be driven; and
operating the control device to estimate a ball trajectory based on one or more sensor measurements.

20. The method of claim 12, further comprising:
operating the mobile cart to follow a target vehicle which includes or has a target mounted on it.
